(19) United States
(12) Patent Application Publication
(10) Pub. No.: US 2009/0014587 A1
(43) Pub. Date: Jan. 15, 2009

(54) AIRCRAFT SAFETY SYSTEM

(76) Inventor: Romolo Lorenzo Bertani, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/064,851

(22) PCT Filed: Aug. 28, 2006
(86) PCT No.: PCT/AU2006/001247

§ 371 Date: Jun. 26, 2008

(30) Foreign Application Priority Data
Aug. 26, 2005 (AU) 2005904665

(51) Int. Cl. B64C 1/32

(52) U.S. Cl. 244/120

(57) ABSTRACT

An aircraft (10) comprising a fuselage (12) having an upper pilotable fuselage portion (10A) and a lower jettisonable fuselage portion (10B), the lower jettisonable fuselage portion (10B) being detachably engaged with the upper pilotable fuselage portion (10A) during normal flight. An upper wing structure (14A) is associated with the upper pilotable fuselage portion (10A) and a lower wing structure (14B) is associated with the lower jettisonable fuselage portion (10B). Releasable engagement means (50, 250) are provided for detachably engaging the lower jettisonable fuselage portion (10B) and the upper pilotable fuselage portion (10A). The releasable engagement means (50, 250) is actuatable in flight to enable the upper pilotable fuselage portion (10A) and the lower jettisonable fuselage portion (10B) to be disengaged from one another. The upper pilotable fuselage portion (10A) can be flown in the absence of the lower jettisonable fuselage portion (10B).

### FIELD OF THE INVENTION

The invention relates to an aircraft safety system that is designed to increase the chances of passenger survival in the event of an accident.

### BACKGROUND OF THE INVENTION

Since the first successful powered piloted flight took place at Kitty Hawk on 17 Dec. 1903, passenger travel by aircraft has become commonplace. Significant advances by engineers, scientists, and manufacturers in a vast array of disciplines, ranging from aircraft design to aircraft materials, have allowed the manufacture and production of aircraft capable of carrying passengers and freight across the globe. The number of passengers worldwide grew from 177 million in 1965 to an estimated 3.3 billion in 2000.

Although air travel is generally safe and reliable, with multiple backup and safety systems, thousands of lives have been lost in air crashes around the globe since the first fatal crash on 17 Sep. 1908. This is despite the best attempts by the pilots to locate a suitable landing site on the ground or at sea and improvements in both pilot training and sophistication of aircraft.

Various solutions have been proposed in an effort to address these aircraft related fatalities. For example, U.S. Pat. No. 6,382,563 to Chiu teaches an aircraft with a severable outer shell and a plurality of individual passenger cabins located within the shell. In the event of an emergency the outer shell is severed and the individual passenger cabins separate, each cabin being equipped with independent oxygen supplies and parachutes. Each cabin segment is then able to float to the ground, under its respective parachute, thereby saving passenger's lives.

Similarly, U.S. Pat. No. 4,699,336 to Diamond teaches an aircraft passenger compartment which contains a mechanism for ejecting the passenger compartment from the fuselage when the aircraft is in danger of crashing. Parachutes are then able to float the passenger compartment to earth.

A common problem with these prior art solutions is that they do not scale effectively. Passenger aircraft continue to increase in size, with the latest design by Airbus, the A380, having a wing span of approximately 80 m, and being capable of carrying over 550 passengers on two separate decks. A further problem associated with aircraft which have segmented passenger capsules is that this system requires duplication of parachute systems and requires sophisticated technology (e.g. rockets and/or lasers) capable of separating each capsule, as well as significant space for both parachute systems and separation mechanisms. This of course in turn leads to increase in weight and manufacturing costs.

### SUMMARY OF THE INVENTION

The invention accordingly provides an aircraft comprising:
a fuselage having an upper pilotable fuselage portion and a lower jettisonable fuselage portion, the lower jettisonable fuselage portion being detachably engaged with the upper pilotable fuselage portion during normal flight;
an upper wing structure associated with the upper pilotable fuselage portion;
a lower wing structure associated with the lower jettisonable fuselage portion;
releasable engagement means for detachably engaging the lower jettisonable fuselage portion and the upper pilotable fuselage portion;
wherein the releasable engagement means is actuatable in flight to enable the upper pilotable fuselage portion and the lower jettisonable fuselage portion to be disengaged from one another; and
wherein the upper pilotable fuselage portion can be flown in the absence of the lower jettisonable fuselage portion.

Preferably the aircraft is a fixed wing passenger aircraft. The upper pilotable fuselage portion preferably includes a passenger compartment, and further includes a tail section and tail engine.

In an embodiment of the invention, the tail section is detachably engaged to the upper pilotable fuselage portion and is disengageable in an emergency condition.

Advantageously, the lower jettisonable portion is able to fly independently after separation from the upper pilotable fuselage portion. The lower jettisonable fuselage portion preferably further includes primary landing gear, fuel tanks and cargo storage compartments.

In preferred embodiments, the lower jettisonable portion further includes a global positioning system adapted to guide the lower jettisonable portion to predetermined safe landing locations. Such safe landing locations are advantageously pre-programmed into the global positioning system such that the lower jettisonable fuselage portion can be automatically guided after separation. Preferably, the safe landing locations are remote from built-up areas and may include designated airports, or the sea.

The upper wing structure preferably includes fuel storage means for fuel used by the upper pilotable fuselage portion after separation from the lower jettisonable fuselage portion.

In an embodiment of the invention the upper wing structure is nested in the lower wing structure during normal flight and acts as a single combined wing structure for the aircraft. Advantageously, the lower wing structure is releasably mounted to the upper wing structure by a releasable vacuum means. The releasable vacuum means is preferably synchronised with the releasable engagement means to enable synchronised detachment of the upper and lower wing structures in an emergency condition.

In an alternate embodiment of the invention the upper wing structure and lower wing structure are separate from one another during normal flight.

Preferably the upper pilotable fuselage portion has auxiliary controls and instrumentation, adapted to allow a person to pilot the upper pilotable fuselage portion after the lower jettisonable fuselage portion has separated from the upper pilotable fuselage portion. The auxiliary controls and instrumentation are separate and in addition to the main controls and instrumentation used to pilot the aircraft prior to separation. The upper pilotable fuselage portion may have an auxiliary piloting area, in which the auxiliary controls and instrumentation are located, which is separate and in addition to a main cockpit which the pilots occupy to pilot the aircraft prior to the lower jettisonable fuselage portion separating.

Advantageously, the releasable engagement means includes an array of releasable engagement mechanisms. Each releasable engagement mechanism may include a detachably engageable jaw or clamping assembly.

In one embodiment of the invention, the releasable engagement means comprises a release bolt having a head, and a clamping assembly. The clamping assembly may comprise a pair of jaws which are movable between an engaged position in which the head of the release bolt is engaged and a release position in which the head of the release bolt is released.

The upper pilotable fuselage portion may include auxiliary landing gear so that the upper pilotable fuselage portion can be landed once the lower jettisonable fuselage portion has been released. The upper pilotable fuselage portion may further include material to improve its buoyancy.

In an embodiment of the invention, the upper pilotable fuselage portion includes seaplane shaped hull geometry to assist in landing on water once the lower jettisonable fuselage portion has been separated.

In alternate embodiments of the invention, the releasable engagement means may comprise a sliding rail arrangement to enable the upper pilotable fuselage portion and lower jettisonable fuselage portion to slide with respect to one another and become disengaged when the releasable engagement means is actuated.

Advantageously, the sliding rail arrangement includes a rack and gear mechanism, and at least one complementary pair of rollers which enable sliding motion between the upper pilotable fuselage portion and lower jettisonable fuselage portion. The sliding rail arrangement preferably further includes a braking mechanism which when activated prevents the upper pilotable fuselage portion and lower jettisonable fuselage portion to slide with respect to one another, and when deactivated, enables the upper pilotable fuselage portion and lower jettisonable fuselage portion to separate.

### BRIEF DESCRIPTION OF THE DRAWINGS

The invention will now be described by way of illustrative example only, with reference to the accompanying drawings, in which:

FIGS. 1A to 1C show front, side and top views respectively of a first embodiment of the modified passenger aircraft of the present invention prior to separation;

FIGS. 2A and 2B show front and side views respectively of the modified passenger aircraft of FIGS. 1A to 1C in the separated configuration;

FIG. 2C shows a top plan view of an upper pilotable portion of the aircraft in the separated configuration;

FIG. 2D shows a cross sectional side view of the wing of the upper pilotable portion of the aircraft shown in FIG. 2C along the line 2D-2D;

FIG. 2E shows a top plan view of the lower jettisonable portion of the modified aircraft in the separated configuration;

FIG. 3 shows a partly schematic cross sectional side view of the modified aircraft along the line 4A-4A of FIG. 1B;

FIG. 4 shows a detailed cross sectional side view of a first embodiment of a releasable engagement mechanism illustrated in FIG. 3;

FIG. 5A shows a partly schematic cross sectional side view similar to that of FIG. 3 with the upper pilotable portion and the lower jettisonable portion in the separated configuration;

FIG. 5B shows detail of a releasable engagement mechanism of FIG. 5A in the separated configuration;

FIGS. 6A to 6C show a perspective, side and cross sectional front views respectively of the releasable engagement mechanism of FIG. 4 in the engaged configuration;

FIGS. 7A to 7C show a perspective, side and cross sectional front views respectively of the releasable engagement mechanism of FIG. 4 in the release position;

FIG. 8 shows a detailed sectional perspective view of a seal assembly between the upper and lower portions of the aircraft;

FIG. 9A shows a partly schematic cross sectional side view of a wing of the aircraft along the lines 9A-9A of FIG. 1C;

FIG. 9B shows the wing of FIG. 9A with the upper and lower wing portions in a separated configuration;

FIG. 9C shows a vacuum manifold for assisting in holding the upper and lower wing portions together;

FIGS. 10A to 10C show perspective, detailed and partly cross sectional side views respectively of a second embodiment of the releasable engagement mechanism of the invention in the engaged position;

FIGS. 11A and 11B show perspective and partly cross sectional side views respectively of a releasable engagement mechanism of FIG. 10A in the disengaged position;

FIGS. 12A to 12D show isometric, front, side, and cross sectional front views respectively of a low altitude passenger aircraft of a further embodiment of the invention prior to separation;

FIGS. 13A to 13D show isometric, front, side, and cross sectional front views respectively of the aircraft of FIGS. 12A to 12D during separation;

FIGS. 14A to 14D show isometric, front, side, and cross sectional front views respectively of a high altitude passenger aircraft of a further embodiment of the invention prior to separation;

FIGS. 15A to 15D show isometric, front, side, and cross sectional front views respectively of the aircraft of FIGS. 14A to 14D during separation;

FIGS. 16A to 16D show isometric, front, and side views respectively of a safety glider aircraft of a further embodiment of the invention prior to separation;

FIGS. 17A to 17C show isometric, front, and side views respectively of the aircraft of FIGS. 16A to 16C during separation;

FIGS. 18A to 18C show isometric, front, and side views respectively of a twin engine aircraft of a further embodiment of the invention prior to separation;

FIGS. 19A to 19C show isometric, front, and side views respectively of the aircraft of FIGS. 18A to 18C during separation;

FIGS. 20A to 20C show isometric, front, and side views respectively of a nested engine high altitude aircraft of a further embodiment of the invention prior to separation;

FIGS. 21A to 21C show isometric, front, and side views respectively of the aircraft of FIGS. 20A to 20C during separation;

FIGS. 22A to 22D show isometric, front, side, and cross sectional front views respectively of a high altitude launcher of a further embodiment of the invention prior to separation;

FIGS. 23A to 23D show isometric, front, and side views respectively of the launcher of FIGS. 22A to 22D during separation;

FIG. 23E shows a cross sectional side view of the ARAVS of FIGS. 22A to 22D during flight into space;

FIGS. 24A to 24D show isometric, front, side, and cross sectional front views respectively of a supersonic delta aircraft of a further embodiment of the invention prior to separation;

FIGS. 25A to 25D show isometric, front, side, and cross sectional front views respectively of the aircraft of FIGS. 24A to 24D during separation;

FIGS. 26A to 26C show isometric, front, and side views respectively of a transonic delta aircraft of a further embodiment of the invention prior to separation;

FIGS. 27A to 27C show isometric, front, and side views respectively of the aircraft of FIGS. 26A to 26C during separation;

FIGS. 28A to 28C show isometric, front, and side views respectively of a tri-stage aircraft of a further embodiment of the invention prior to separation;

FIGS. 29A1 to 29C show isometric, front, and side views respectively of the aircraft of FIGS. 28A to 28C during separation;

FIGS. 29D to 29G show isometric, front, and side views respectively of the upper portion of the aircraft of FIGS. 29A1 to 29C without the aft engine module;

FIGS. 30A to 30C show isometric, front, and side views respectively of a bi-plane of a further embodiment of the invention prior to separation;

FIGS. 31A to 31C show isometric, front, and side views respectively of the bi-plane of FIGS. 30A to 30C during separation;

FIGS. 32A1 to 32D show isometric, front, side, and cross sectional front views respectively of a bi-wing high altitude launcher of a further embodiment of the invention prior to separation;

FIGS. 33A2 to 33D show isometric, front, side, and cross sectional front views respectively of the launcher of FIGS. 32A1 to 32D during separation;

FIGS. 34A to 34C show isometric, front, and side views respectively of a crank-V aircraft of a further embodiment of the invention prior to separation;

FIGS. 35A to 35C show isometric, front, and side views respectively of the aircraft of FIGS. 34A to 34C during separation;

FIGS. 36A1 to 36C show isometric, front, and side views respectively of a box-wing aircraft of a further embodiment of the invention prior to separation;

FIGS. 37A to 37C show isometric, front, and side views respectively of the aircraft of FIGS. 36A1 to 36C during separation;

FIGS. 38A to 38D show isometric, front, side, and cross sectional front views respectively of a high altitude passenger aircraft incorporating a sliding release mechanism of a further embodiment of the invention prior to separation;

FIGS. 38E and 38F show enlarged cross sectional front views of the railing system of FIGS. 38A to 38D prior to separation;

FIGS. 39A to 39C show isometric, side, and cross sectional front views respectively of the aircraft of FIGS. 38A to 38D during separation;

FIGS. 40A to 40C show isometric, front, and side views respectively of the aircraft of FIGS. 38A to 38D after separation;

FIGS. 40D and 40E show enlarged cross sectional front views of the railing system of FIGS. 38A to 38D after separation;

FIG. 41 shows a cross sectional front view of the aircraft of FIGS. 38A to 38D prior to separation with the braking system actuated

FIGS. 42A to 42B show enlarged cross sectional front views of the activated braking system of the aircraft of FIGS. 38A to 38D during flight; and

FIG. 43 shows schematically a hydraulic release mechanism for separating the upper and lower portions of the aircraft.

### DETAILED DESCRIPTION OF THE EMBODIMENTS

Throughout the following description like reference numerals have been used to identify like components in the alternate preferred embodiments.

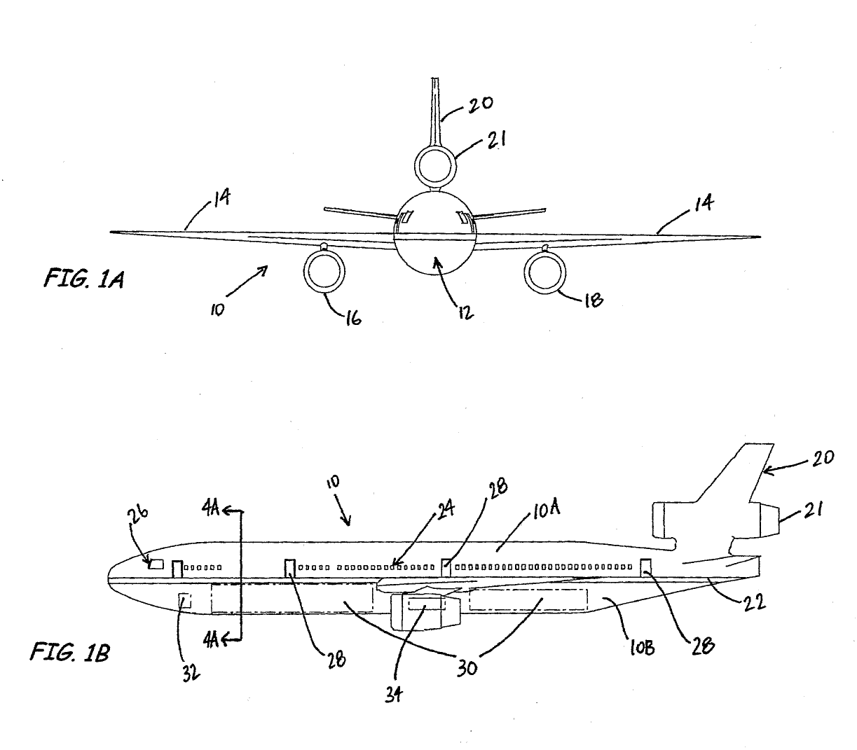

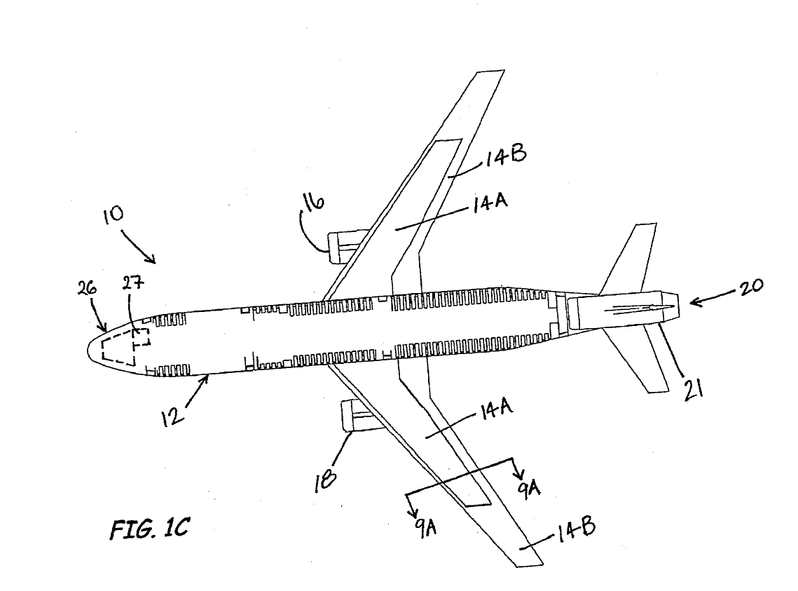

Referring firstly to FIGS. 1A to 1C, a modified passenger aircraft 10 in accordance with an embodiment of the present invention is shown as it would fly normal operational circumstances. The passenger aircraft 10 has a fuselage 12, a set of wings 14, wing-mounted engines 16, 18, and a tail section 20 which houses a tail engine 21.

The modified passenger aircraft 10 is divided into an upper pilotable portion 10A and a lower jettisonable portion 10B along a sealable interface 22. As will be described in greater detail below, upon occurrence of an emergency condition, the lower jettisonable portion 10B is configured to be disengaged from the upper pilotable portion 10A.

The upper pilotable portion 10A includes a passenger compartment 24 and exit doors 28. A main cockpit 26 of the aircraft is located at the front of the upper pilotable portion 10A and contains the controls and instrumentation used to pilot the aircraft when the upper pilotable portion 10A and the lower jettisonable portion 10B are attached to one another in normal operational circumstances.

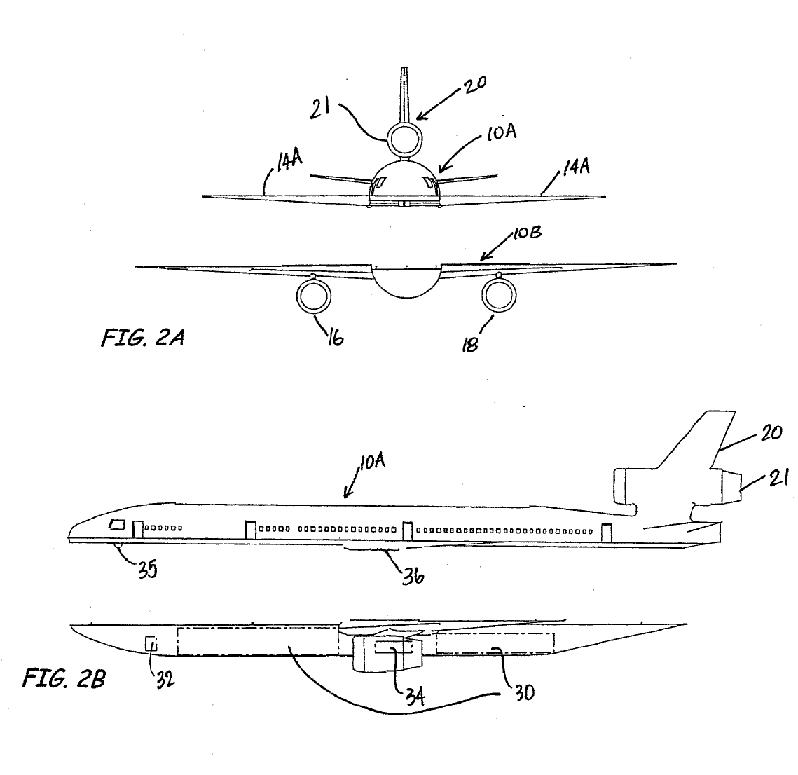

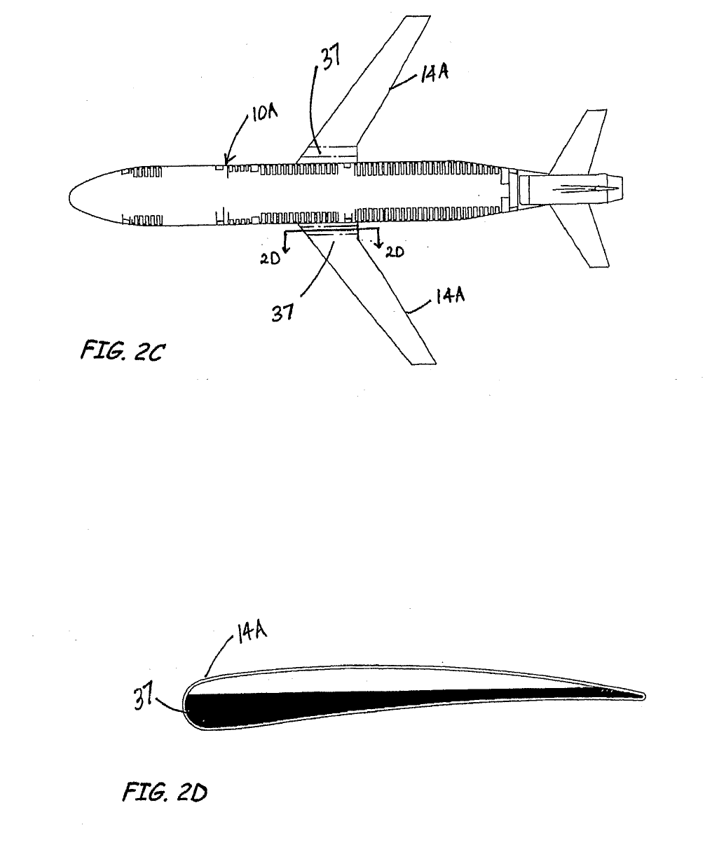

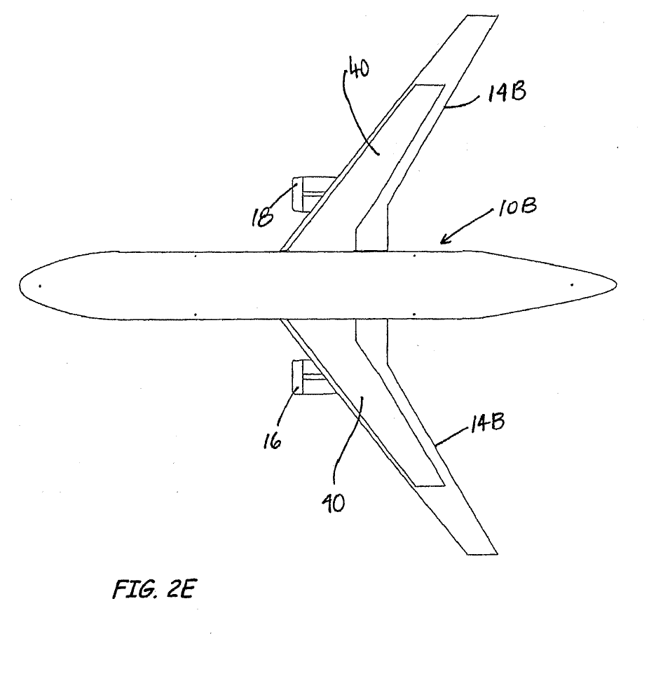

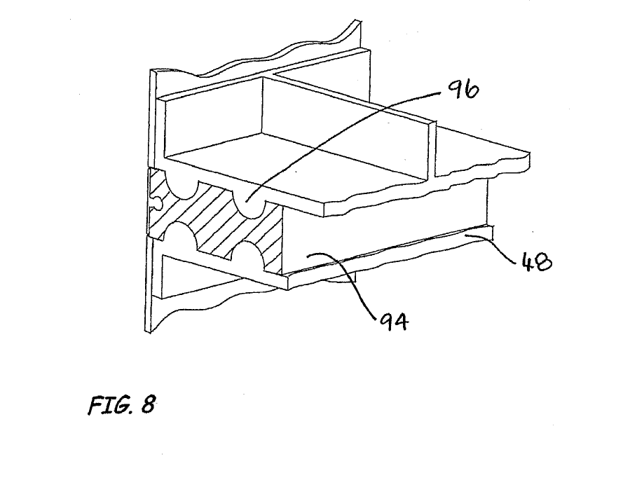

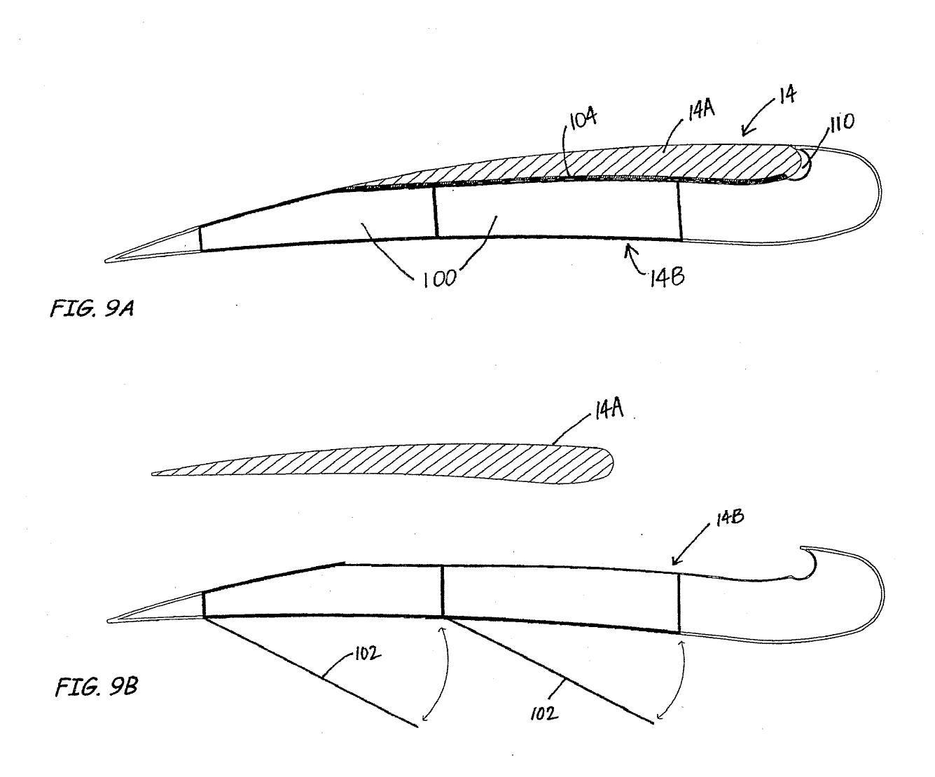

Wings 14 are comprised of upper wing portions 14A and lower wing portions 14B. Upper wing portions 14A are carried on the upper pilotable portion 10A of the aircraft, and lower wing portions 14B, together with the wing engines 16, 18, are carried on the lower jettisonable portion 10B of the aircraft. Under normal flying conditions, the upper and lower wing portions 14A and 14B are firmly engaged with one another in the manner illustrated in FIG. 9A to define the aircraft wings 14. FIG. 2E shows how the lower wing portions 14B are provided with complimentary shaped recesses 40 which accommodate the upper wing portions 14A. Also located in the lower jettisonable portion are front and rear cargo compartments 30, and front and main landing gear compartments 32, 34 for housing the conventional landing gear (not shown) of the modified passenger aircraft 10.

Referring now to FIGS. 2A and 2B, the upper pilotable and lower jettisonable portions 10A, 10B of the modified passenger aircraft 10 of FIGS. 1A to 1C are shown in the disengaged or separated configuration. Typically disengagement occurs as result of an emergency condition, such as damage occurring to one of the components of the lower jettisonable portion 10B of the aircraft 10. The lower jettisonable portion 10B of the aircraft 10 includes front and rear cargo compartments 30, main wing fuel tanks carried in the lower wing portions 14B and wing engines 16, 18. When the cargo compartments 30 are fully loaded and the main wing fuel tanks full, the lower jettisonable portion 10B can represent almost half the entire laden mass on the aircraft 10. It is therefore advantageous in an emergency condition to jettison the lower portion 10B of the aircraft 10A so as to increase the chances of the upper pilotable portion landing safely.

The upper pilotable portion 10A includes upper wing portions 14A, tail section 20, tail engine 21, and wing-mounted fuel tanks 37 carried in the upper wing portions 14A. FIG. 2D shows a cross-sectional view of the wing mounted fuel tanks 37 located in the upper wing portions 14A. The upper pilotable portion 10A is capable of flying independently with the entire complement of the pilots, crew and passengers. The upper pilotable portion 10A is also provided with auxiliary front and main landing gear 35, 36 which allows the pilotable portion 10A to make an emergency landing.

The upper pilotable portion 10A is preferably also provided with auxiliary controls and instrumentation, such as a steering yoke, altimeter, radio and engine controls, to allow a person to pilot the upper pilotable portion 10A after separation from the lower jettisonable portion 10B of the aircraft 10. The auxiliary controls are preferably independent from the main controls and instrumentation which are used to pilot the modified passenger aircraft 10 prior to the upper and lower portions 10A, 10B separating. The auxiliary controls and instrumentation are advantageously located in an auxiliary piloting area 27 which is preferably separate and independent from the main cockpit 26. The auxiliary piloting area 27 is schematically shown in FIG. 1C as a small room located behind the main cockpit 26. Consequently if the main cockpit 26 is damaged or inaccessible to the pilots, for instance due to a build up of smoke, the upper pilotable portion 10A can be separated from the lower jettisonable portion 10B and may be flown from the auxiliary piloting area 27.

In alternate embodiments, the upper pilotable portion 10A may be piloted after separating from the lower jettisonable portion 10B using either the main controls and instrumentation or the auxiliary controls and instrumentation. In this case the auxiliary controls may be located in the main cockpit 26 or may be located in an auxiliary piloting area 27 as described above. Alternatively, auxiliary controls and instrumentation are not provided and the upper pilotable portion 10A is piloted after separating from the lower jettisonable portion 10B using the main controls and instrumentation in the main cockpit 26.

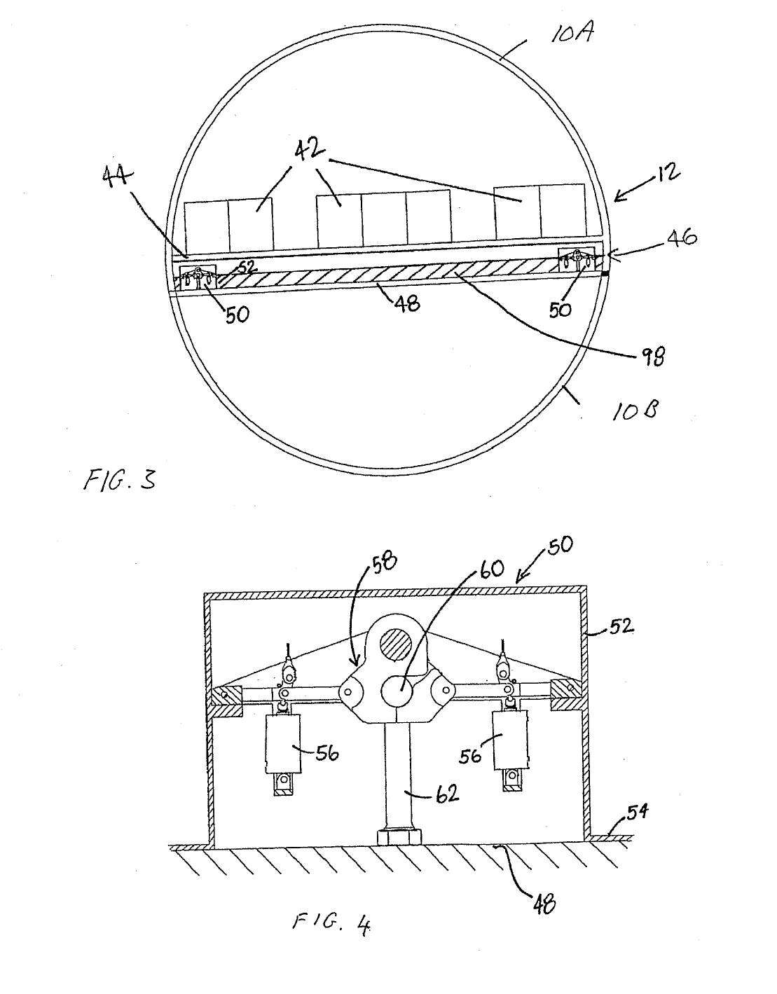

Referring now to FIG. 3, upper and lower portions 10A and 10B of the fuselage on the aircraft are shown in cross section. The upper pilotable portion 10A includes passenger seating 42 affixed to a lower floor 44 of the upper pilotable portion 10A of the aircraft. A plenum 46 is defined between the lower floor 44 and an upper ceiling 48 on the lower jettisonable portion 10B of the aircraft. The plenum 46 preferably accommodates 6 releasable engagement mechanisms 50 located in respective housings 52. The releasable engagement mechanisms are preferably arranged as a front pair located in the fore of the modified passenger aircraft 10, a central pair located adjacent the aircraft's wings 14, and a rear pair located in the aft of the aircraft 10.

The releasable engagement mechanisms 50 serve to hold the upper pilotable and lower jettisonable portions 10A and 10B of the aircraft 10 together under most conditions until disengaged. Each housing 52 is securely mounted within the upper portion 10A of the aircraft as shown in FIG. 3. A lower flange 54 of each housing 52 abuts firmly against the upper ceiling 48 of the lower portion 10B of the aircraft 10. Each releasable engagement mechanism 50 includes a pair of hydraulic actuators 56 which act on a jaw assembly 58 to hold the expanded head 60 of a release bolt 62 in an engaged position. The release bolt 62 is firmly mounted to the upper ceiling 48 of the lower jettisonable portion 10B. When the jaw assemblies 58 are caused to open under the influence of the hydraulic actuators 56, the head 60 of the release bolt 62 is released causing the entire jettisonable portion 10B of the aircraft to be released from the upper pilotable portion 10A and to drop away from the upper pilotable portion 10A.

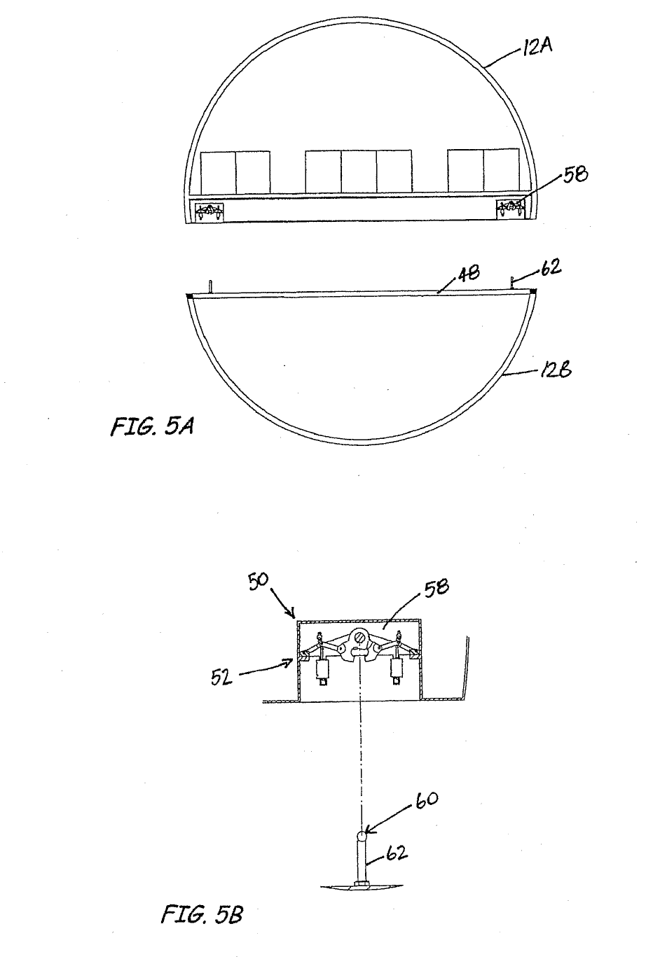

FIG. 5A shows the upper pilotable portion 10A separating from the lower jettisonable portion 10B in more detail after the releasable engagement mechanisms 50 have been actuated. FIG. 5B is an enlarged detail of a releasable engagement mechanism 50 in the disengaged position. The release bolt 62 has been released from the jaw assembly 58 of the releasable engagement mechanism 50 and has separated from the releasable engagement mechanism 50.

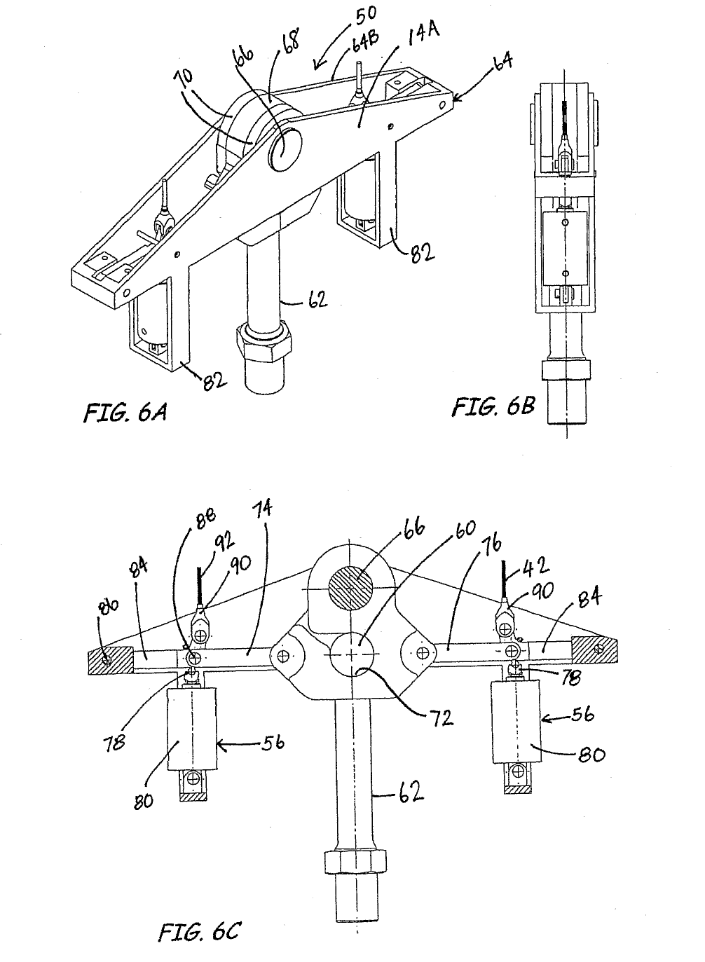

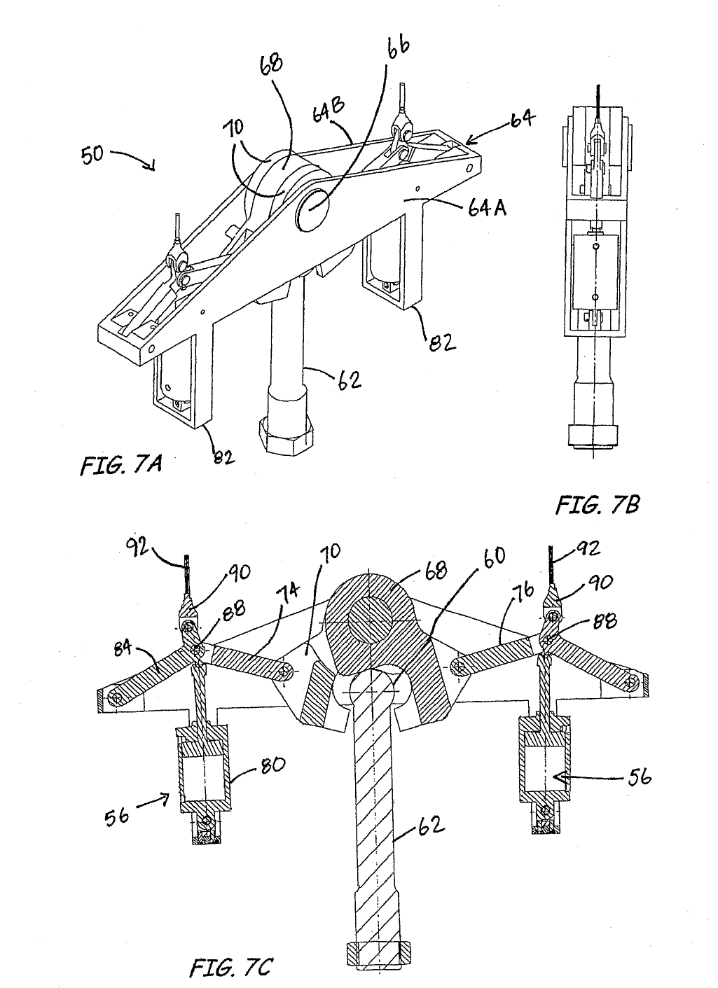

Operation of the releasable engagement mechanism 50 is illustrated in more detail in FIGS. 6A to 6C and 7A to 7C. Referring first to FIGS. 6A to 6C, the releasable engagement mechanism 50 includes a frame 64 formed from first and second spaced apart triangular plates 64A and 64B joined at each end. A central pin 66 bridges the apices of the plates, and a pair of inner and outer jaws 68 and 70 are mounted rotatably to the central pin 66. FIGS. 6A to 6C show the releasable engagement mechanism in the engaged position, the jaws defining restraining socket 72 within which the expanded head 60 of the release bolt is held captive. Opposite sides of the jaws 68 and 70 are pivotally mounted to respective lever arms 74 and 76. The lever arms 74 and 76 are in turn mounted pivotally to the ends of hydraulic rams 78 which reciprocate within cylinders 80 to form the hydraulic actuators 56. The base of each cylinder 80 is mounted to stirrup portions of the frame 64. Outer lever arms 84 have outer fixed pivot points 86 at opposite base ends of the frame, and inner pivot points 88, about which the inner lever arms 74 and 76 and the actuators 78 are also arranged to pivot. Clevise assemblies 90 are mounted pivotally to upper portions of the lever arms 84, and cables or con rods 92 extend from each of the clevises.

Referring now to FIGS. 7A to 7C, the releasable engagement mechanism 50 is shown in a release position. In the release position, the hydraulic actuators 56 are activated to displace the pivot points 88 upwardly, thereby causing the inner and outer lever arms 74 and 84, and 76 and 84, to pivot towards one another, thereby urging the inner and outer jaws 68 and 70 open and freeing the expanded head 60 of the release bolt 62. Simultaneous release of all 6 releasable engagement mechanisms will cause the lower jettisonable portion 10B of the aircraft 10 to be jettisoned from the upper pilotable portion 10A. In the event of hydraulic failure, manual actuation is effected via upward pulling on the cables or rods 92 extending from the devises 90. This can be achieved via corresponding turnbuckle assemblies located in secure positions above the lower floor 44 of the upper pilotable portion 10A of the aircraft.

It will be appreciated that both the manual and hydraulic activation mechanisms will be subject to various security systems with limited override features, to ensure that accidental or unauthorised release does not occur.

FIG. 8 shows, a seal assembly including a sealing gasket 94 for providing a sealable and cushioning interface between the upper and lower portions 10A, 10B of the aircraft. The gasket 94 is formed from a suitable elastic material, and is suitably profiled, as is the upper ceiling 48 of the lower portion 10B of the aircraft and a lowermost floor 96 of the upper portion 10A of the aircraft, to permit contained movement of the two portions relative to each other. A layer of firm material is provided above the lowermost floor 96, it is indicated schematically at 98 in FIG. 3, to increase the buoyancy of the upper pilotable portion of the aircraft in the event of a water landing.

Referring now to FIGS. 9A and 9B, the upper and lower wing portions 14A and 14B of the wing 14 are shown in more detail. The lower wing portion 14B is fitted with fuel tanks 100 which are provided with fuel purgers, such as purge flaps 102 or other purging mechanism, for allowing fuel to be purged from the lower wing portion 14B as soon as it separates from the upper wing portion 14A. This minimises the chances of the lower jettisonable portion 10B exploding on impact. The upper wing portion 14A nests snugly within the lower wing portion 14B. A vacuum manifold arrangement 104, which is illustrated more clearly in FIG. 9C, is provided to ensure that the upper and lower wing portions are held in engagement with one another during normal flying conditions. The vacuum manifold 102 includes a series of alternating ribs 108 and channels 106 which communicate with a vacuum manifold 110. The ribs may be in the form of corrugations defined in the upper surface of the lower wing portion 14B or the lower surface of the upper wing portion 14A.

The vacuum manifold 110 allows a vacuum to be more readily created. The vacuum manifold 110 feeds into the channels 106 so that the pressure in the vacuum manifold 110 influences the pressure in the channels 106. The use of multiple channels improves the reliability of the attachment of the upper wing portion 14A to the lower wing portion 14B as a pressure failure in one channel will not affect the pressure in other channels.

On actuation of the releasable engagement mechanisms 50, the vacuum is simultaneously released to allow the upper and lower wing portions 14A, 14B to disengage from one another in the manner illustrated in FIG. 9B. It will be appreciated that both the upper and lower wing portions 14A, 14B are fitted with flap and aileron assemblies. In particular, the upper wing portion 14A has relatively sufficient auxiliary flaps and ailerons to allow the upper pilotable portion 10A of the aircraft to be flown and controlled normally after separation from the lower jettisonable portion 10B.

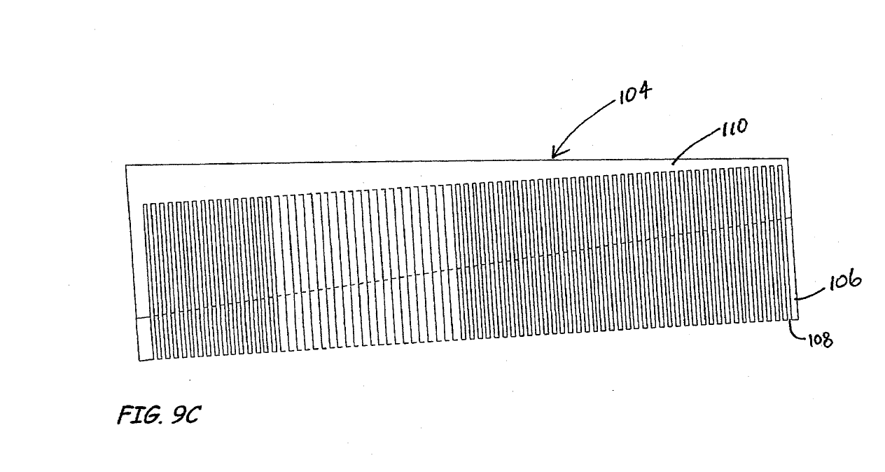

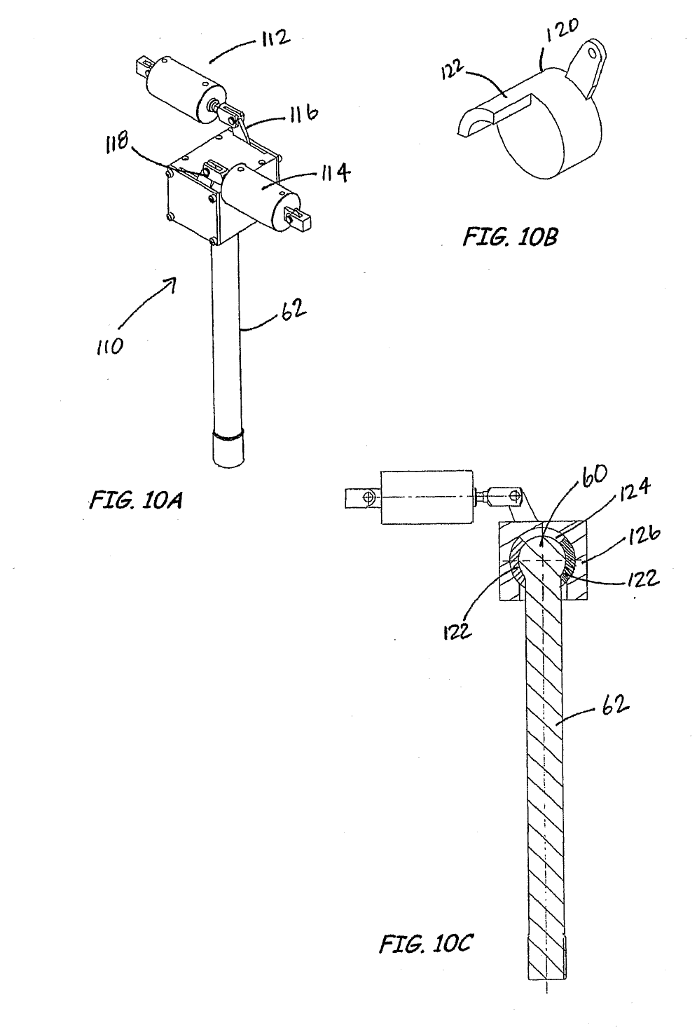

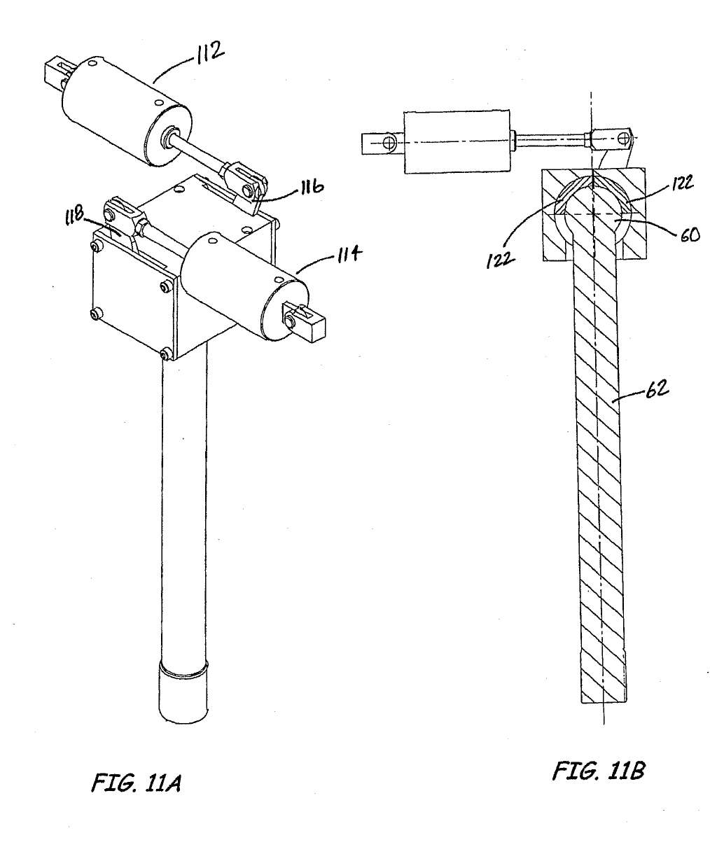

Referring now to FIGS. 10A and 10B, a second embodiment of a releasable engagement mechanism 110 is shown for effecting a controlled disengagement of the release bolt 62. FIGS. 10A to 10C show the releasable engagement mechanism 110 in the engaged position. The releasable engagement mechanism 110 includes a pair of hydraulic actuators 112 and 114, the arms of which are pivotally connected to respective lever arms 116 and 118 extending from rotary catches 120. The catches 120 carry arcuate detents 122 which move within the corresponding cylindrical cavity 124 defined within a socket box 126. The arcuate detents 122 are moveable between an engaged position illustrated in FIG. 10C in which they detain the expanded head 60 of the-released bolt 62, and a released position illustrated in FIG. 11B, in which the rams of the actuating cylinders 112 and 114 are extended to pivot the detents 122 towards one another to free the release bolts 62.

FIGS. 11A and 11B show the releasable engagement mechanism 110 in the release position. The catches 120 have been rotated so that the arcuate detents 122 move to a release position and the expanded head 60 of the release bolt 62 is released from the socket box 126.

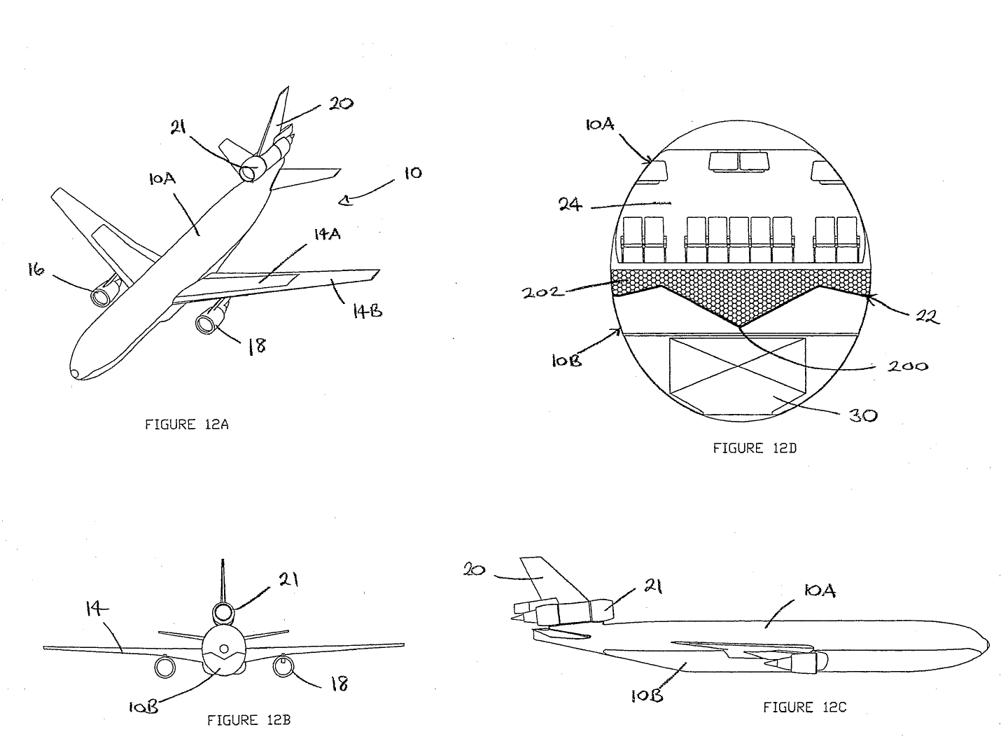

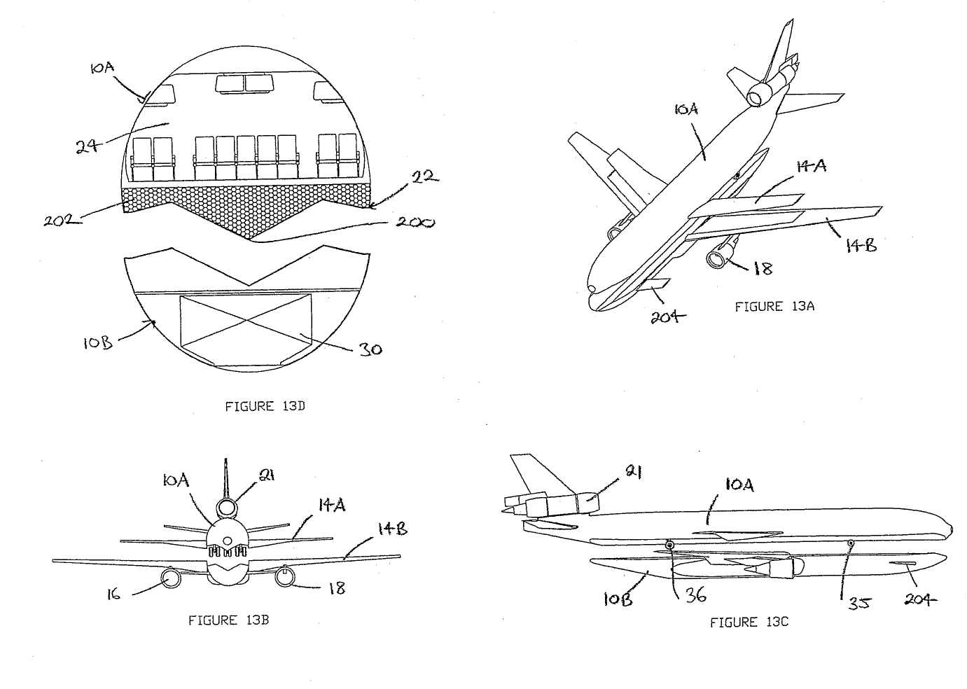

A further embodiment of the invention is illustrated in FIGS. 12A-12D and 13A-13D. Referring first to FIGS. 12A-12D there is shown a nested wing aircraft 10 as described above, comprising upper pilotable portion 10A and lower jettisonable portion 10B. As most clearly shown in FIGS. 12D and 13D, the upper pilotable portion 10A incorporates a seaplane hull geometry including a V-shaped hull 200. The V-shaped hull 200 provides a water cutting edge, and together with spray strips 202 on both sides of the hull 200, reduces the water impact load of the upper pilotable portion 10A and assists in a successful landing and flotation on water. Upper pilotable portion 10A is also provided with a buoyancy section 202 which is used for flotation and stability at sea. The buoyancy section 202 is preferably comprised of low density composite foam which is water, fire, and impact resistant in order to meet safety requirements.

The aircraft of FIGS. 12A-12D and 13A-13D preferably further includes a pair of deployable canards 204 as part of the lower jettisonable portion 10B. These canards are used for longitudinal pitch stability and are employed after the lower jettisonable portion 10B is separated from the upper pilotable portion 10A.

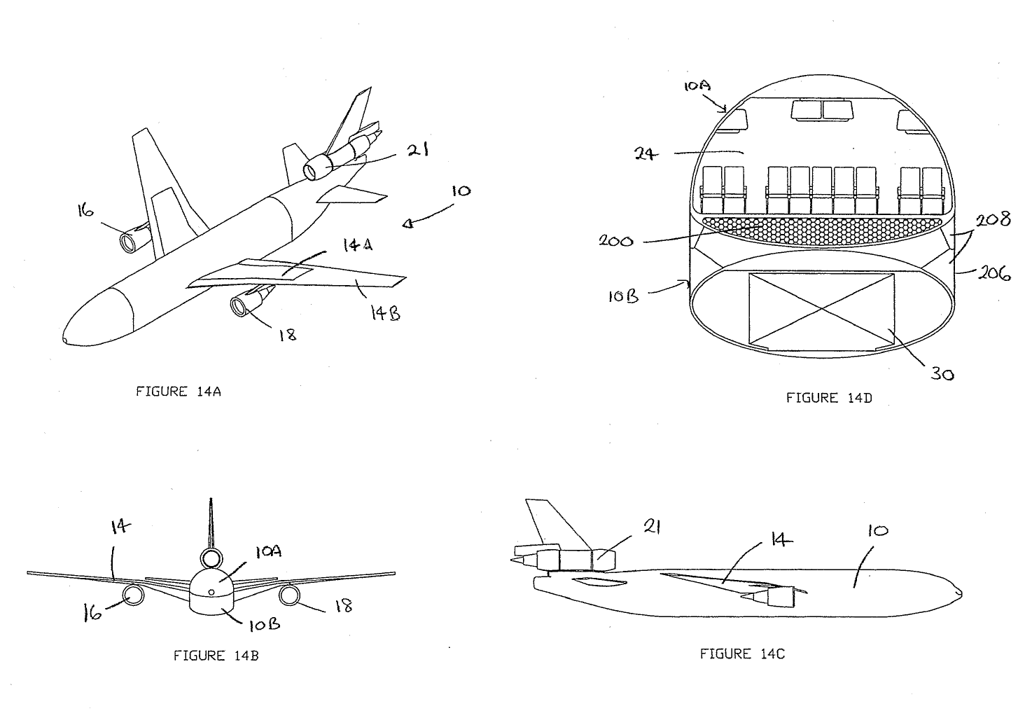

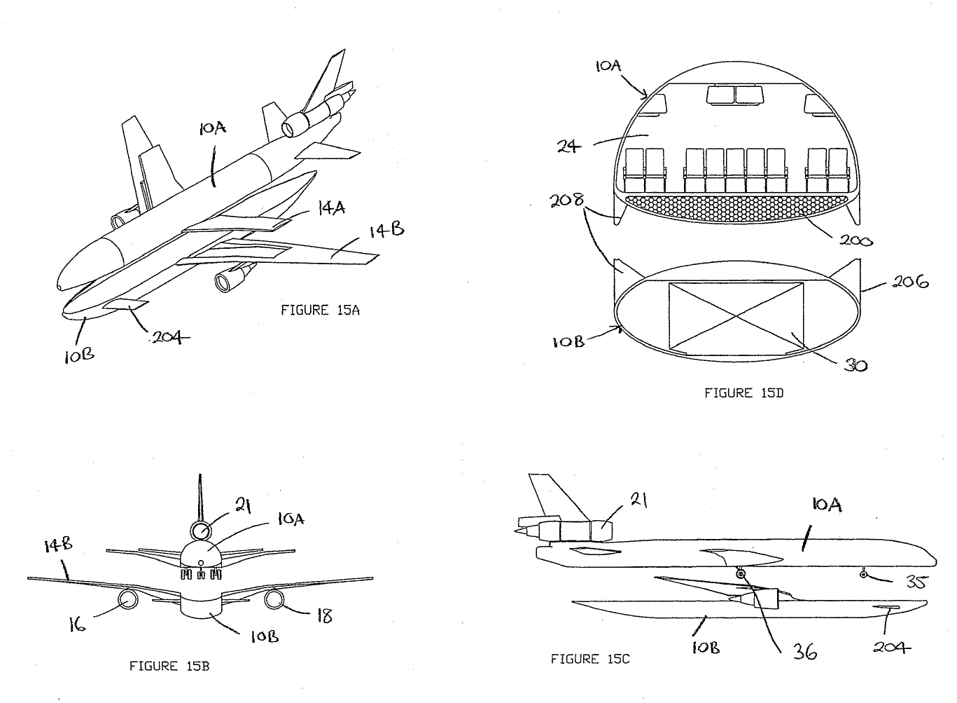

Referring now to FIGS. 14A-14D and 15A-15D, a further embodiment of aircraft 10 is shown. In this embodiment, aircraft 10 is adapted for high altitude flight and separation. Aircraft 10 has nested wings 14, and upper and lower portions 10A, 10B as described above. In this embodiment, the upper pilotable portion 10A and lower jettisonable portion 10B are formed with elliptical cross sections which are designed to hold internal pressure during normal operation and during emergency flight. The upper pilotable portion 10A is therefore able to separate from the lower jettisonable portion at high altitude while both portions remain pressurized. Aircraft 10 is further provided with a cowling 206 and vibration mitigation features in the form of supports 208.

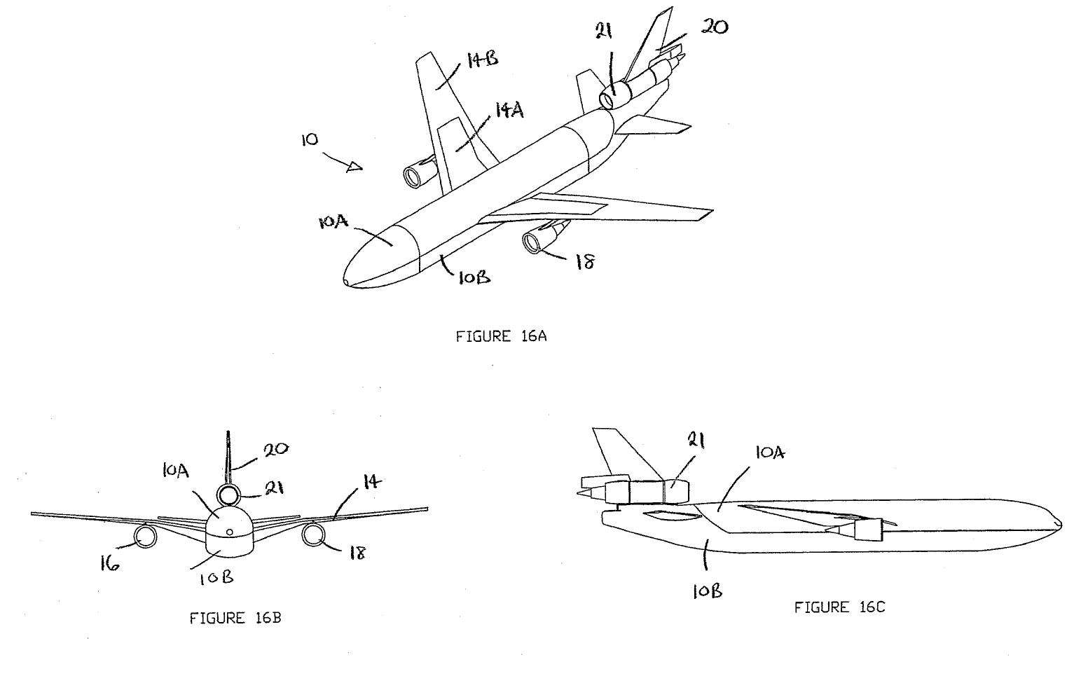

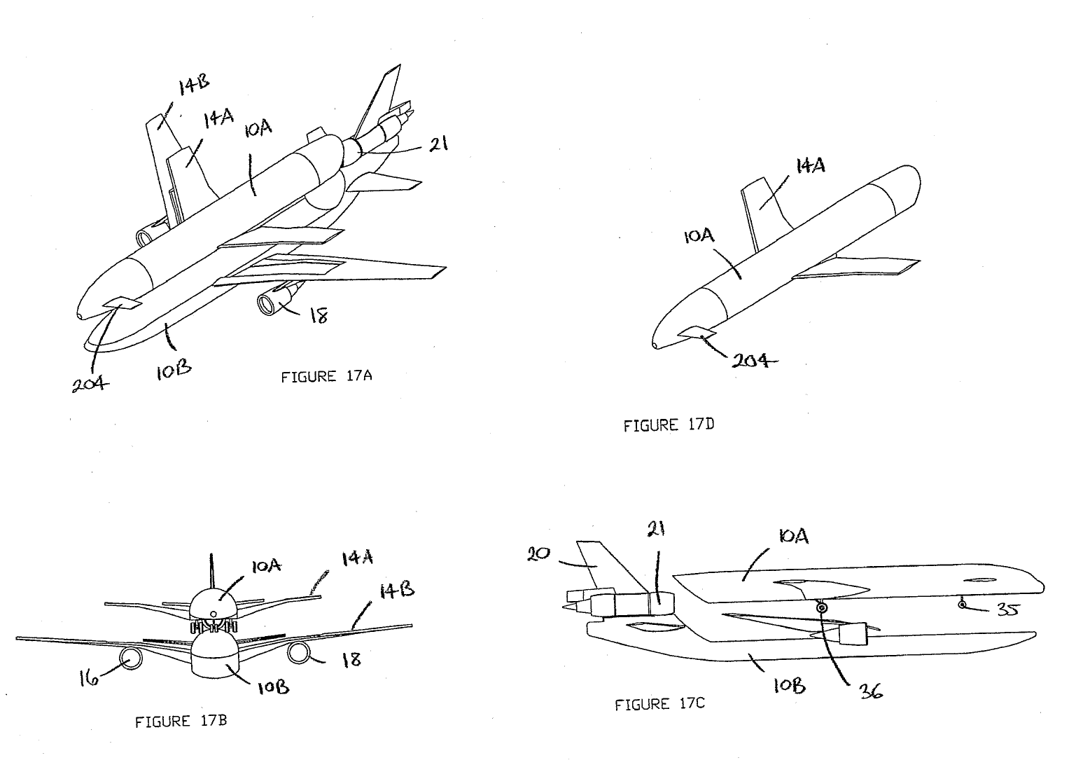

FIGS. 16A-16C and FIGS. 17A-17D illustrate a further embodiment of the invention in which the upper pilotable portion 10A of aircraft 10 is modified to fly as a safety glider in the event of an emergency condition. In this embodiment, after separation from the lower jettisonable portion 10B, the upper pilotable portion 10A remains a pilot controlled vehicle, is light in weight, and intended for gliding purposes only. The upper pilotable portion 10A includes an auxiliary power unit and related equipment necessary for an emergency landing including deployable ventral canards 204. The upper pilotable portion 10A is shown in its gliding configuration in FIG. 17D. The majority of the weight of the aircraft 10 remains with the jettisonable portion 10B including lower wing portions 14B, main engines 16, 18, tail section 20 and tail engine 21, as best illustrated in FIG. 17C.

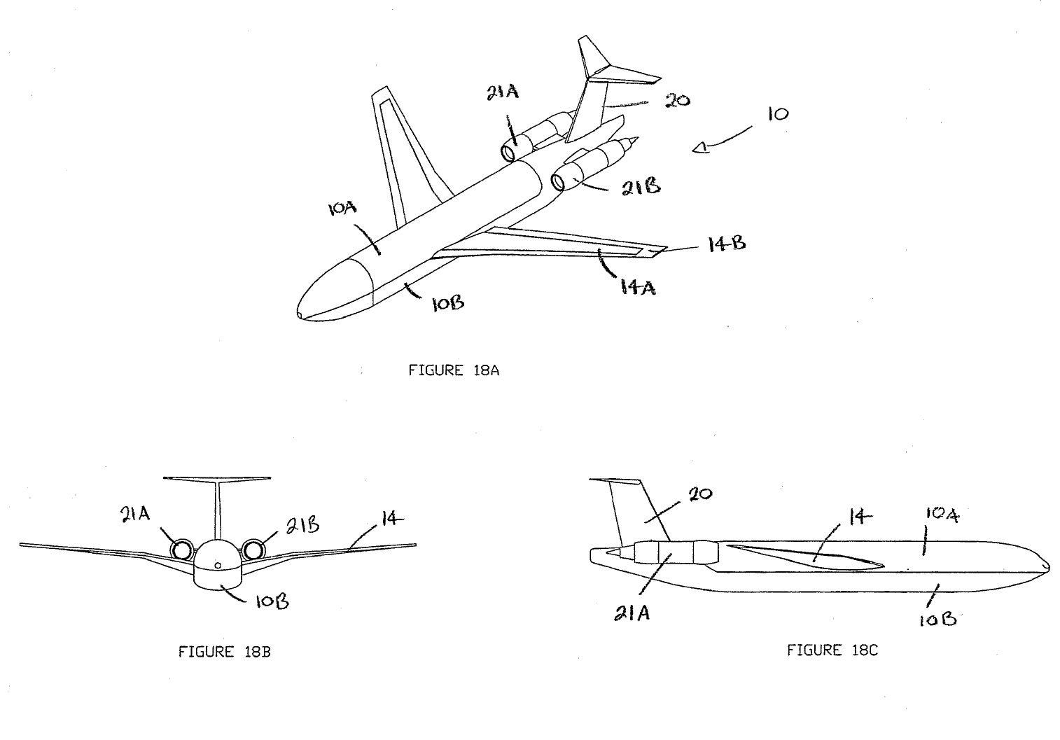

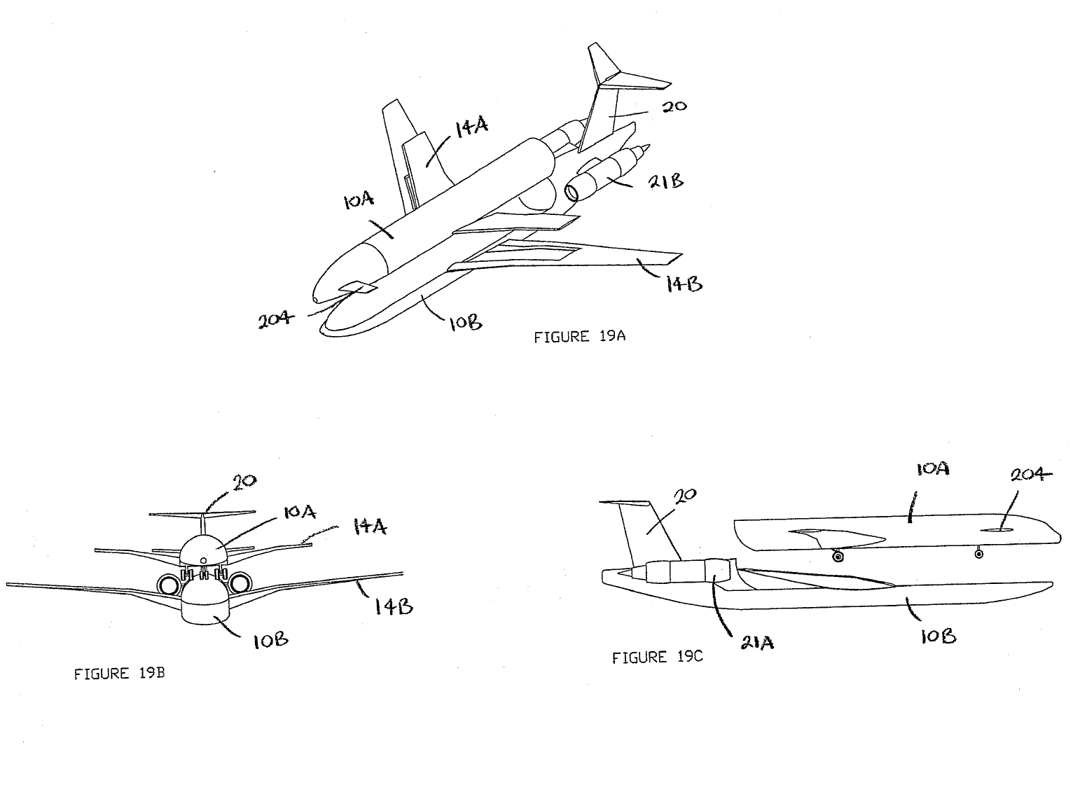

FIGS. 18A-18C and FIGS. 19A-19C illustrate a further gliding embodiment similar to that described above in relation to FIGS. 16A-16C and FIGS. 17A-17D. In this embodiment, aircraft 10 is adapted for high altitude flight and separation, and incorporates twin tail engines 21A, 21B which is typical of small to medium range passenger aircraft.

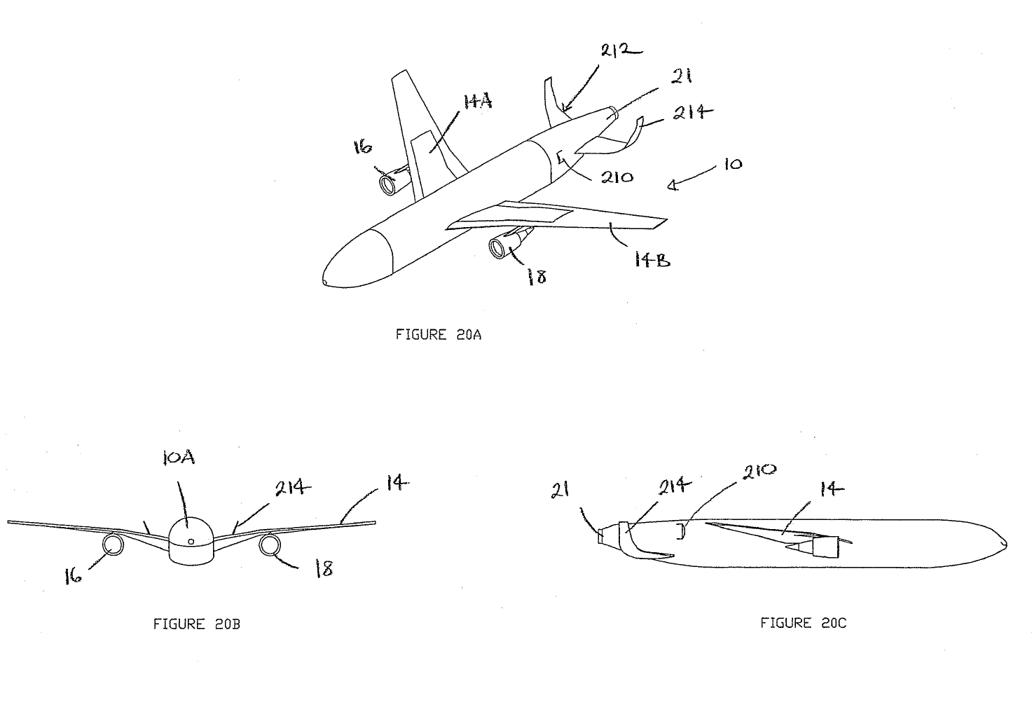

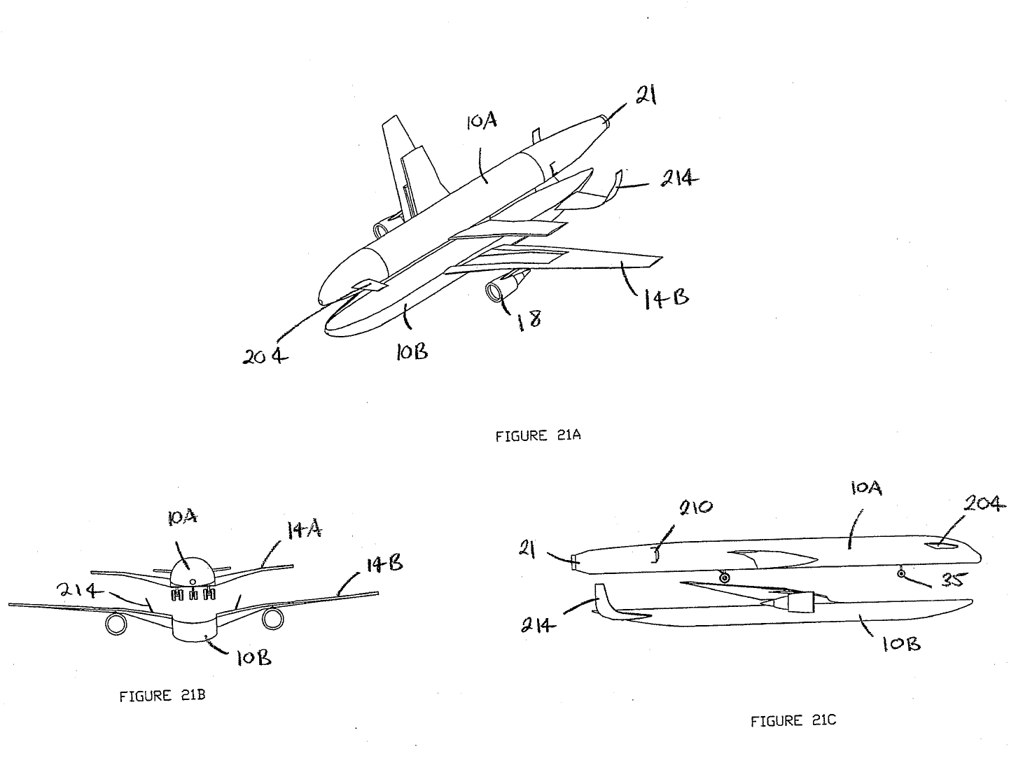

A further embodiment of the invention is shown in FIGS. 20A-20C and FIGS. 21A-21C. In this embodiment, the tail engine 21 is nested in the aft fuselage 12 of the aircraft in upper pilotable portion 10A. Nested tail engine 21 includes associated air intakes. 210. The aircraft 10 of this embodiment is adapted for high altitude flight and separation and includes a distinct horizontal stabiliser 212 incorporating a pair of rudders 214. The horizontal stabiliser 212 is provided on the lower jettisonable portion 10B of the aircraft 10. In the event of an emergency, the tail section 20 together with horizontal stabiliser 214 is jettisoned with the lower portion 10B of the aircraft, as best illustrated in FIG. 21C.

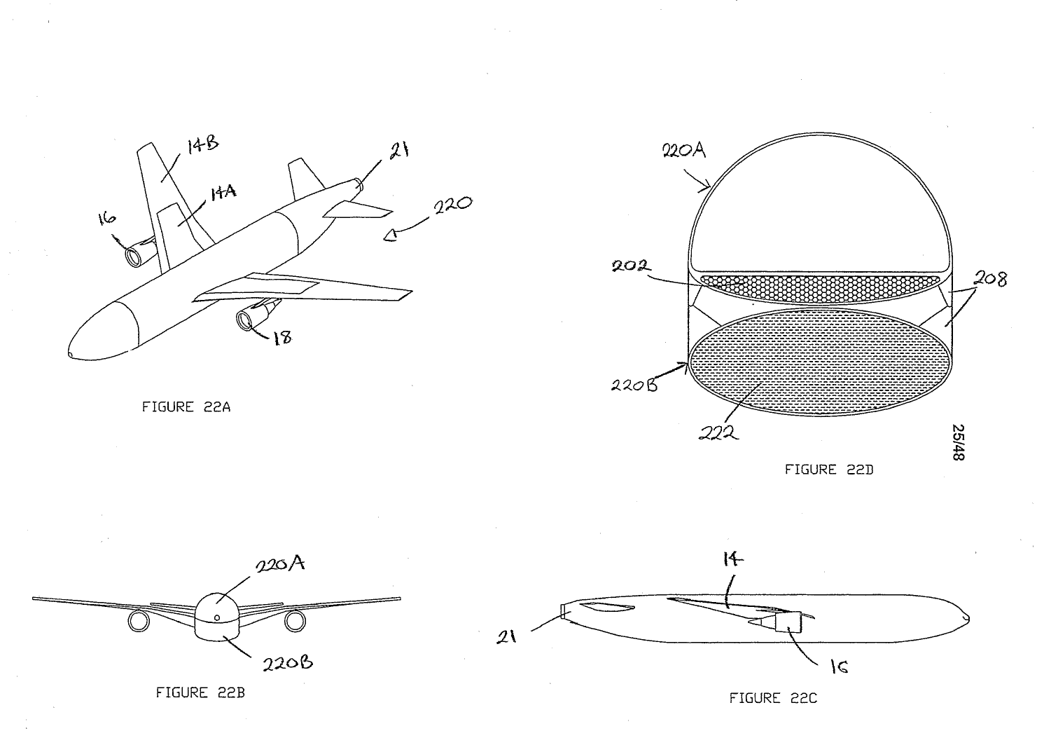

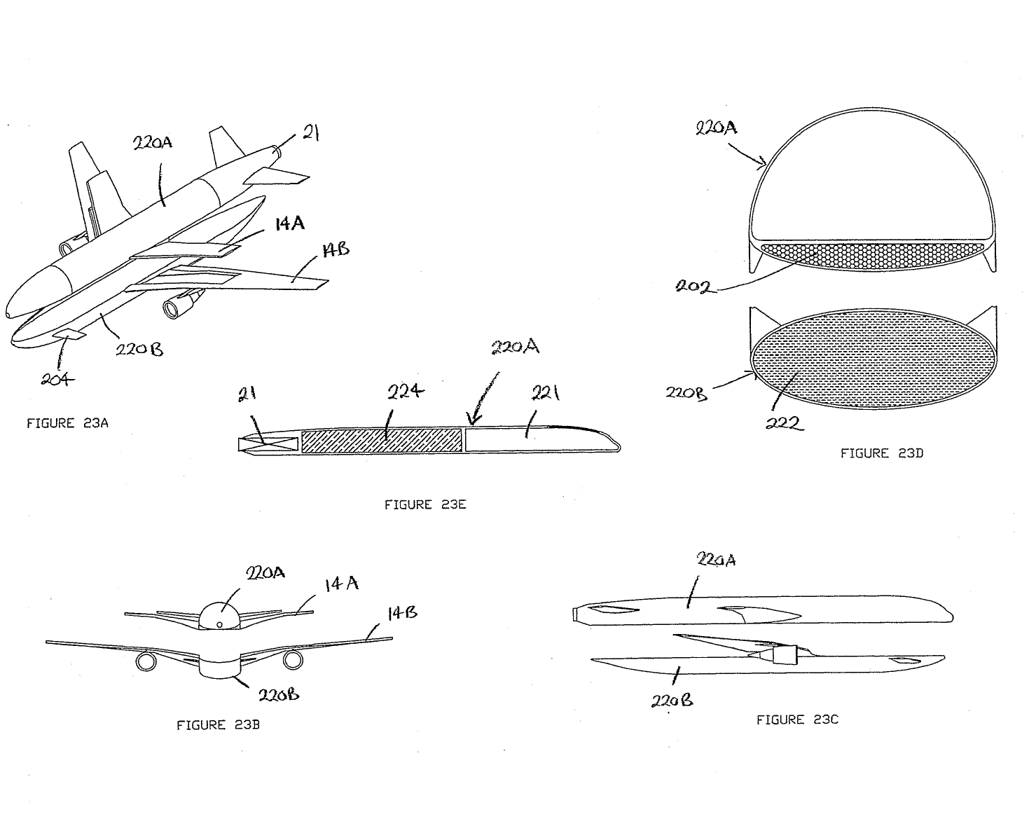

Referring now to FIGS. 22A-22D and 23A-23E an embodiment of the invention applied to a low earth orbit re-entry vehicle launcher 220 is shown. This embodiment incorporates the nested wing configuration 14A, 14B of earlier embodiments.

In this embodiment, the upper pilotable portion 10A of earlier embodiments takes the form of an autonomous rocket assisted vehicle section (ARAVS) 220A, and the lower jettisonable portion 10B takes the form of a reusable high attitude transport launcher 220B. The ARAVS 220A is an autonomous space vehicle intended to carry a payload 221 into space which may include space equipment and/or passengers.

The two sections 220A, 220B are launched as a single aircraft and in the first stage of launching will climb to a predetermined launch altitude using liquid (or repackable solid) fuel 222. At this point the reusable launcher 220B is caused to separate from the ARAVS 220A and returns to its original destination. The reusable launcher 220B includes deployable ventral canards 204. After separation, the ARAVS 220A continues its mission into low altitude orbit up to approximately 100 km using a supply of solid or liquid rocket fuel 224. The ARAVS 220A is designed for re-entry conditions for maximum safety for possible passenger flight and utilises thrust vector control for directional control.

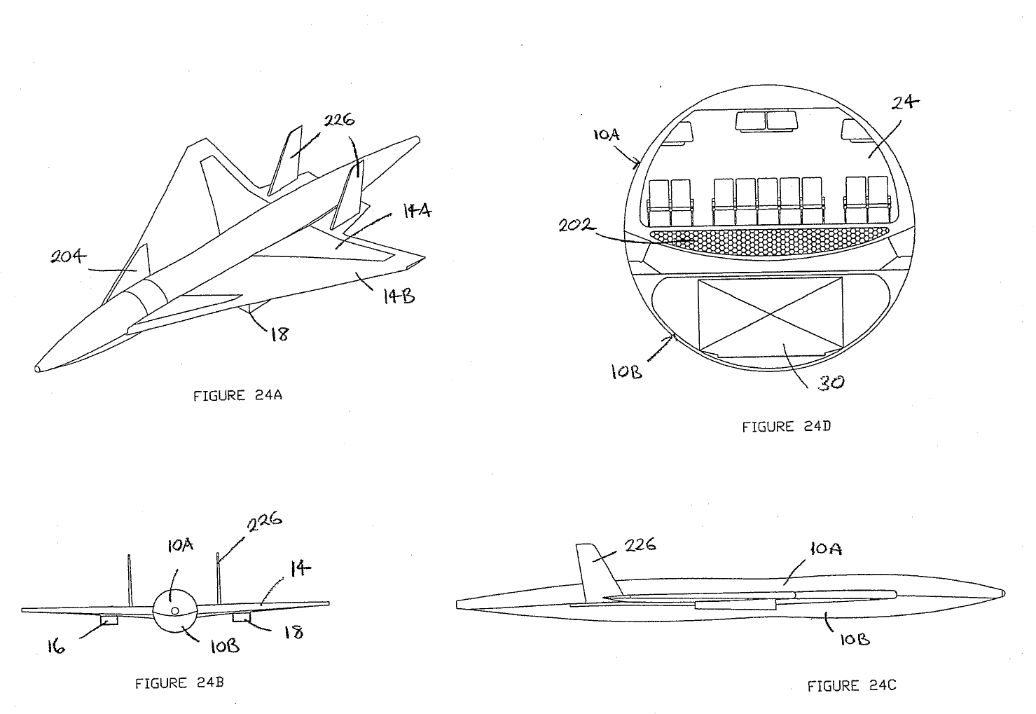

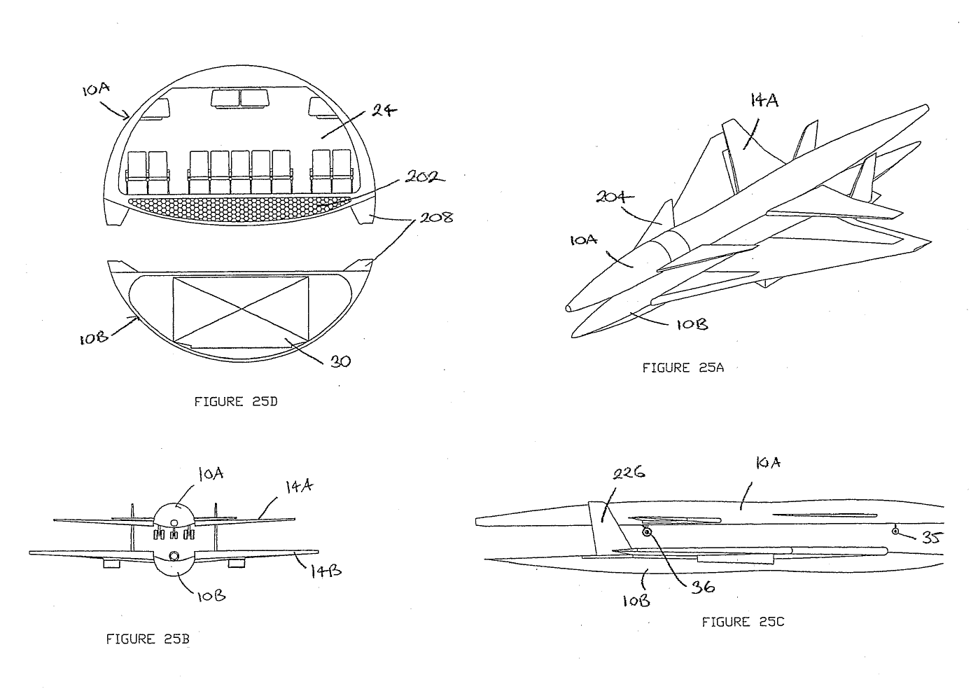

A further embodiment of the invention is illustrated in FIGS. 24A-24D and FIGS. 25A-25D. This embodiment is a supersonic delta aircraft incorporating a supersonic delta wing design for speeds generally greater than 1 Mach number. In this embodiment, twin vertical stabilisers are employed in the aft-strakes 226. The aft-strakes 226 are integrally formed with the wings 14B of the lower portion 10B of the aircraft 10. Upper pilotable portion 10A includes canards 204 which are nested in the wings 14B of the lower portion 14B prior to separation. The pilotable portion 10A includes the necessary features for autonomous flight after separation as described in relation to earlier embodiments and may further include an engine (not shown) for a power glide.

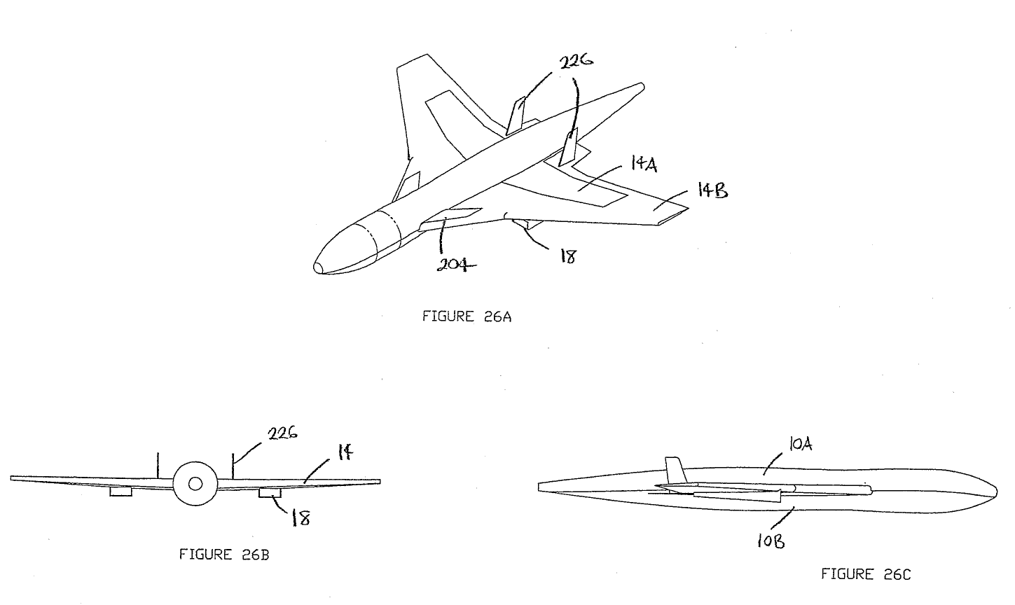

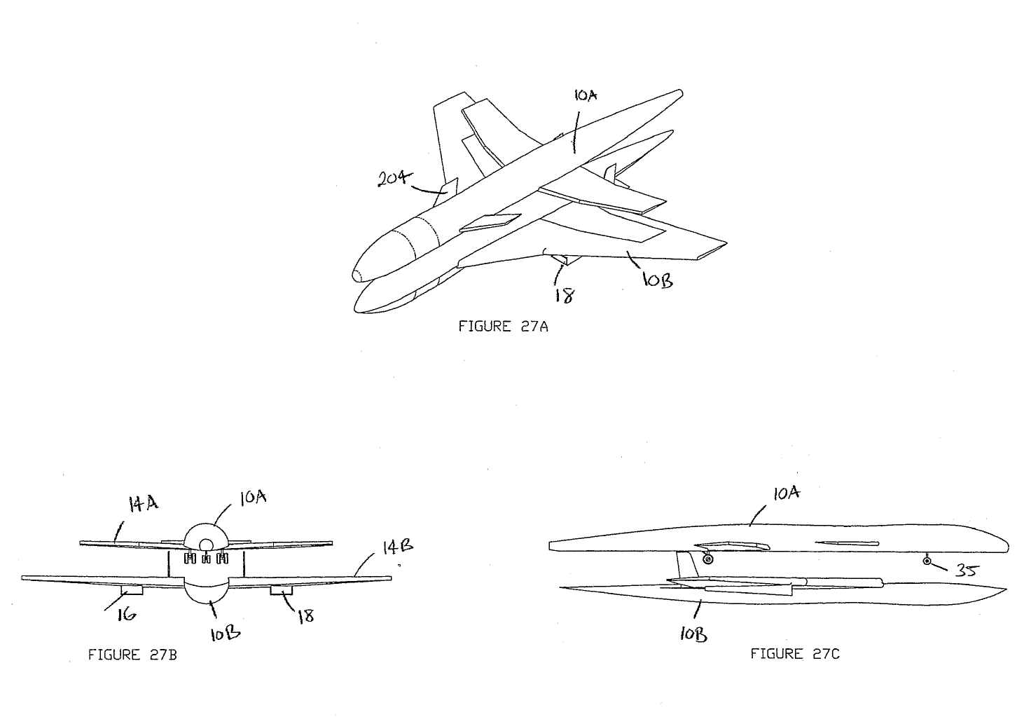

FIGS. 26A-26C and FIGS. 27A-27C illustrate a further embodiment of the invention. This embodiment of the invention is generally identical to that described above in relation to FIGS. 24A-24D and FIGS. 25A-25D except that this aircraft is a transonic delta. The wings 14 are optimised for transonic speed which is in the range of 0.8 to 1.2 Mach number. Again, the pilotable portion 10A may optionally include an engine (not shown) for a power glide, and otherwise has the necessary features for autonomous flight after separation as described in relation to earlier embodiments.

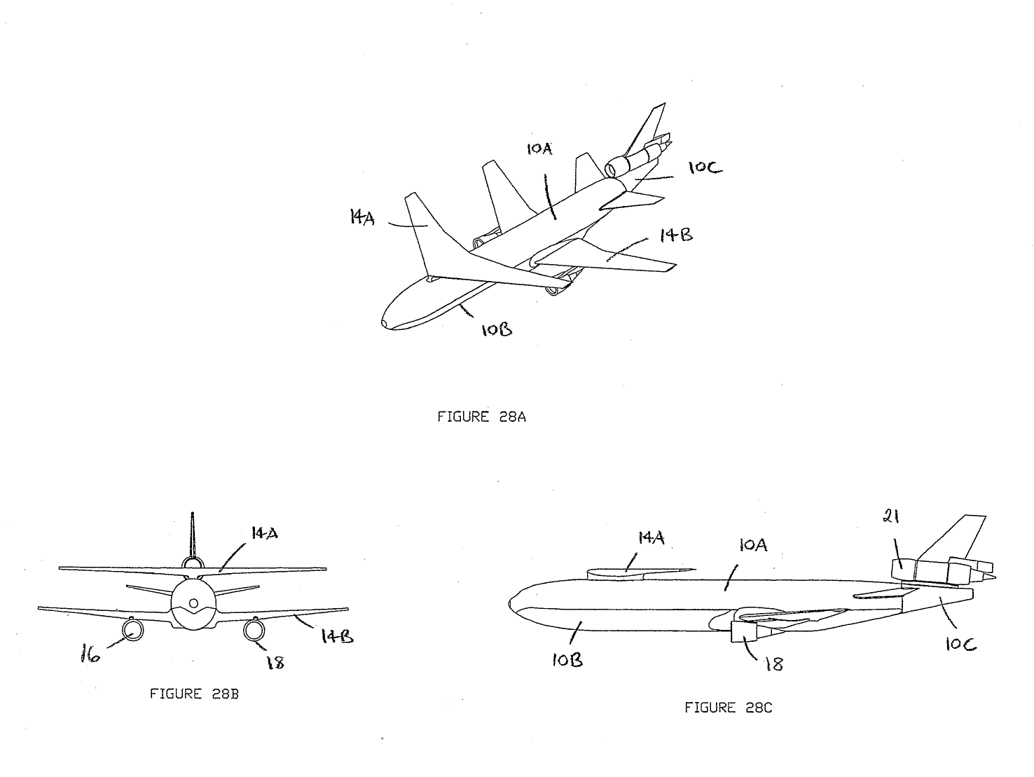

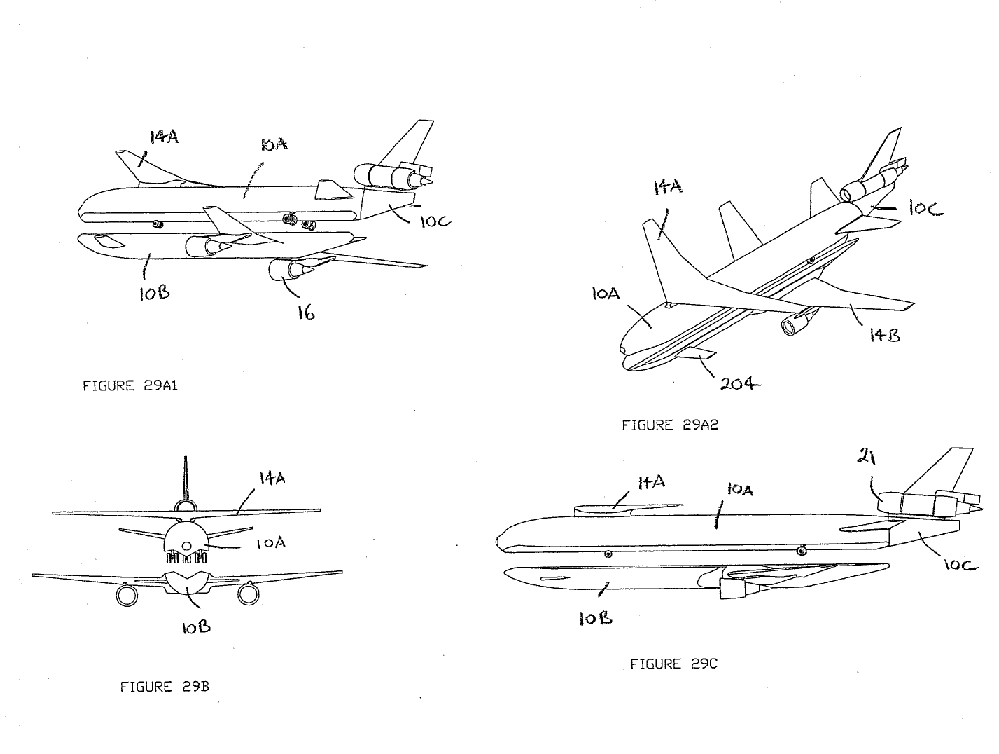

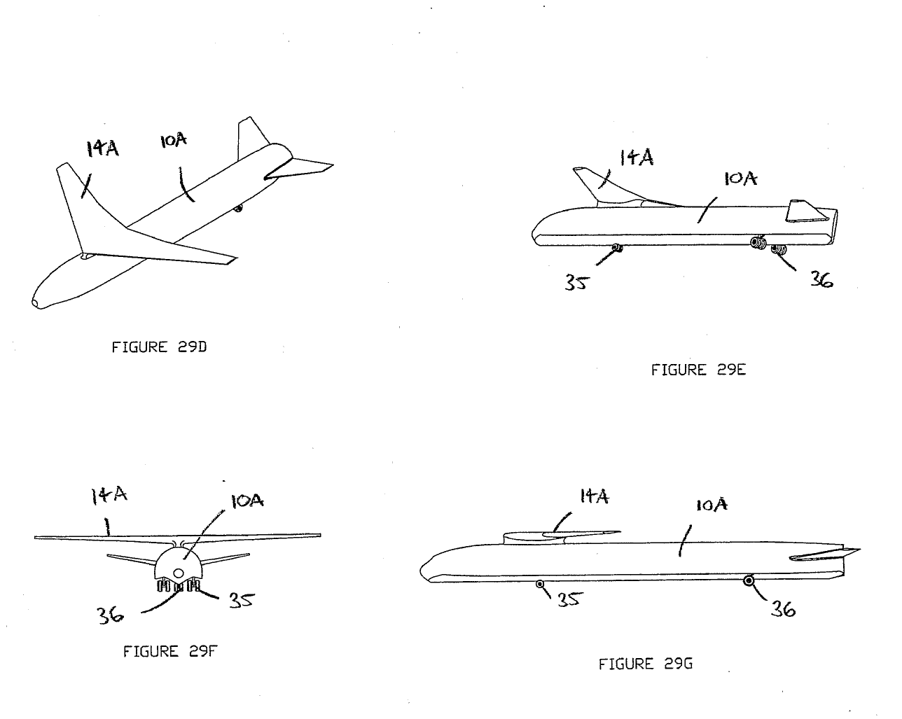

A yet further embodiment of the invention is shown in FIGS. 28A-28C and FIGS. 29A1-29G. This embodiment is a further extension of the embodiments described above, and includes a third deployable aircraft module. Referring particularly to FIGS. 28C, 29C, and 29E, the aircraft 10 of this embodiment comprises 3 modules—upper pilotable portion 10A and lower jettisonable portion 10B as previously described, and an additional deployable aft engine module 10C which houses the tail engine 21. Tail engine 21 has two functions, first to provide thrust during normal flight and secondly to be used in case of an emergency for a power flight to a destination and safe landing. In the event of tail engine or rudder failure, the aft module 10C can be jettisoned from the pilotable portion 10A. In this case, upper pilotable portion 10A will perform as a high altitude wing glider as described earlier.

The upper pilotable portion 10A incorporates a seaplane hull geometry, as described in relation to FIG. 12D, which makes it suitable for a successful landing and flotation on water, with or without a tail engine. Further, upper pilotable portion includes a pair of wings 14A which are not nested in the wings 14B of lower jettisonable portion 10B. The provision of high wings 14A on the upper pilotable portion assists in landing the upper portion 10A safely on water.

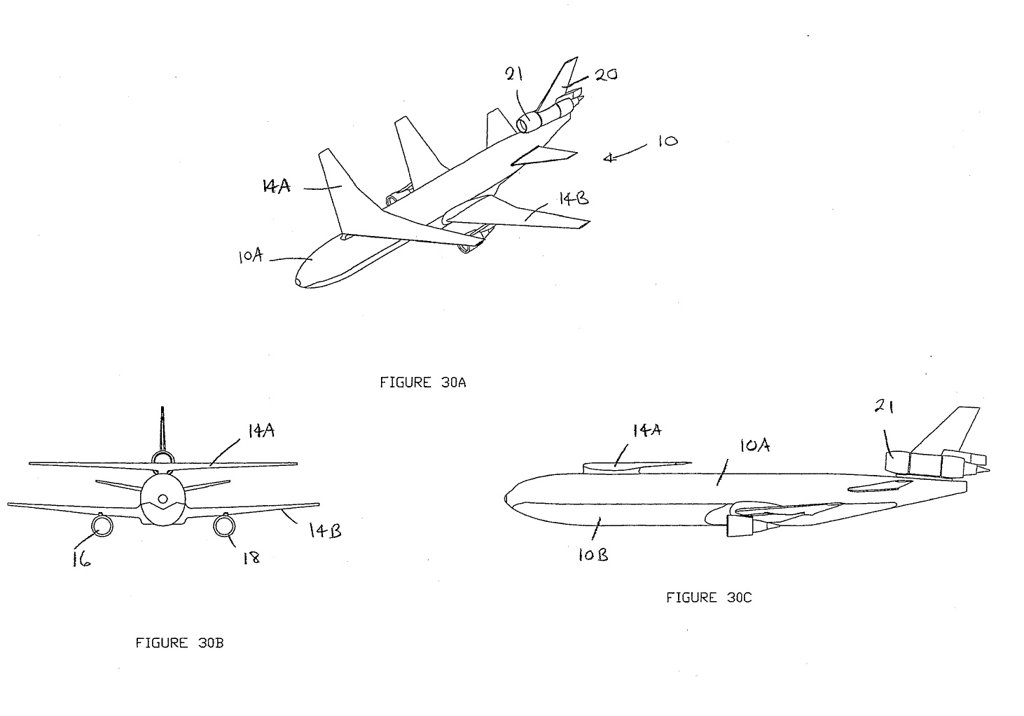

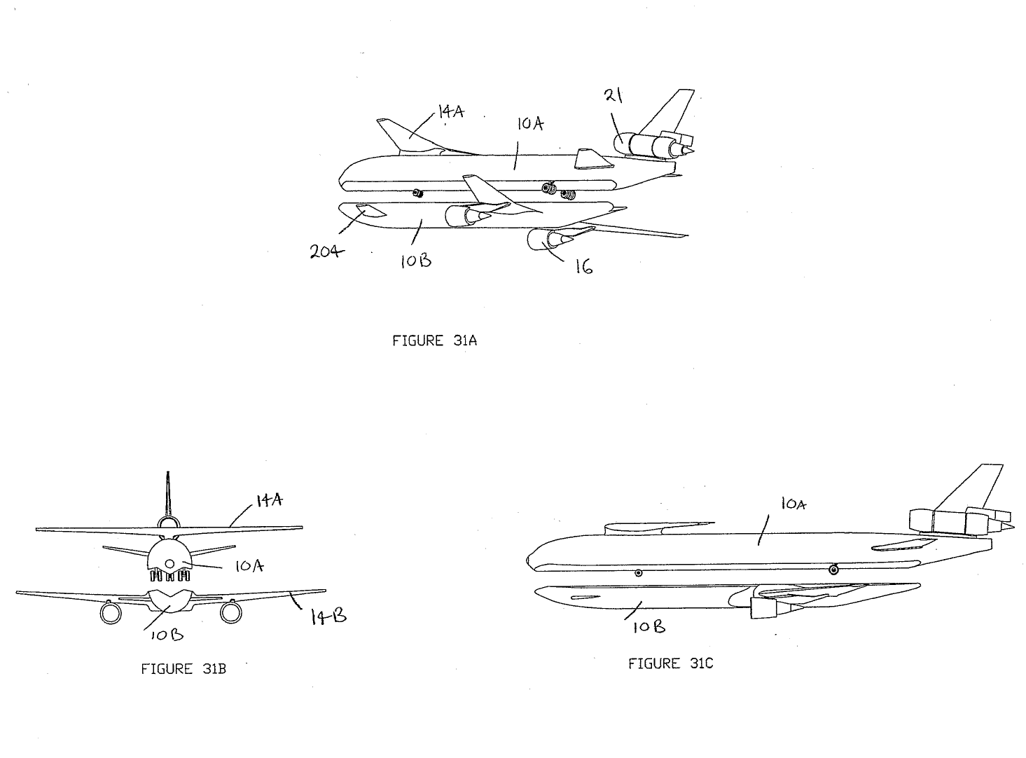

FIGS. 30A-30C and FIGS. 31A-31C illustrate a further embodiment of the invention, namely a bi-plane adapted for low altitude, non-pressurized separation. The bi-plane 10 includes an upper pilotable portion 10A and lower jettisonable portion 10B. Upper pilotable portion 10A includes a pair of non-nested high wings 14A. High wings 14A are considered to provide safety advantages when landing the upper pilotable portion on water, thus minimising the risk of an accident. The upper pilotable portion 10A includes all the necessary features described above for safe transportation of passengers during normal and emergency flights, and also includes a seaplane hull geometry.

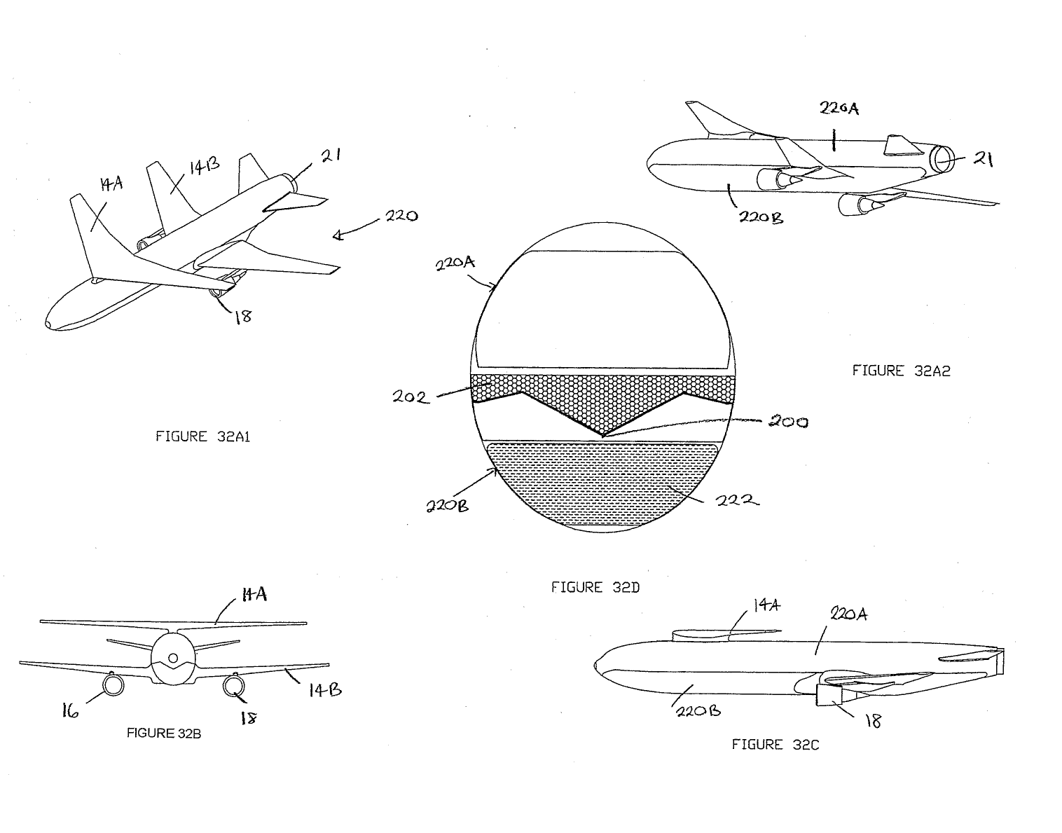

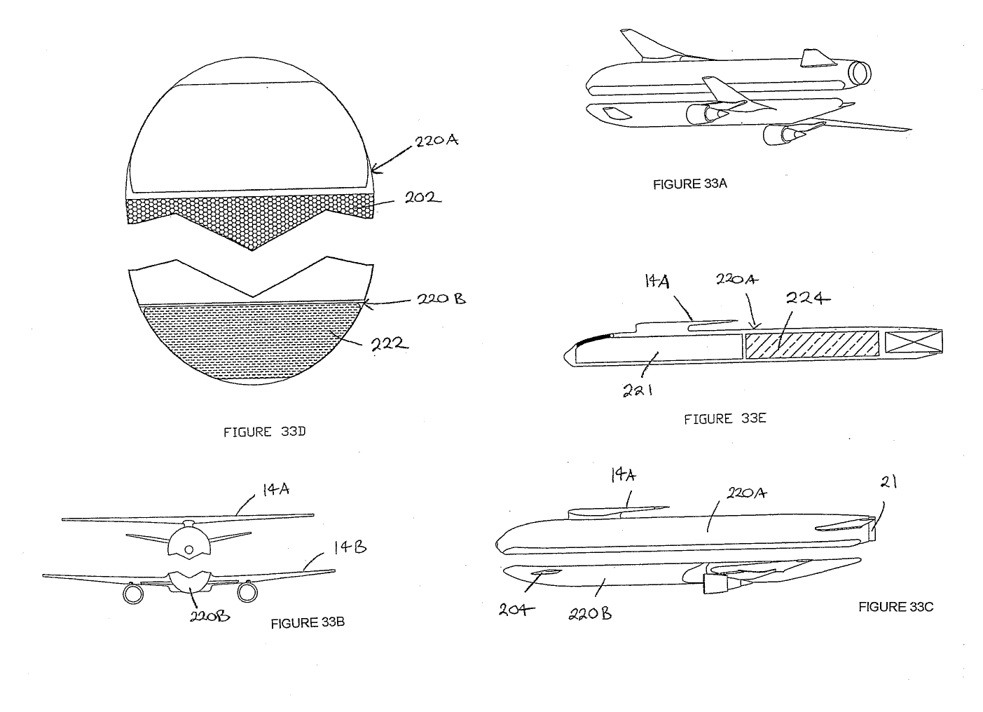

A further embodiment of the invention is shown in FIGS. 32A1-32D and FIGS. 33A2-33E. These Figures show a low earth orbit launcher 220 similar to that described in relation to FIGS. 22A-22D and 23A-23E. This embodiment differs in that the wings 14A and 14B are not nested and are instead provided in a bi-wing configuration. This arrangement of the wings 14A, 14B provides improved structural efficiency in the launcher 220.

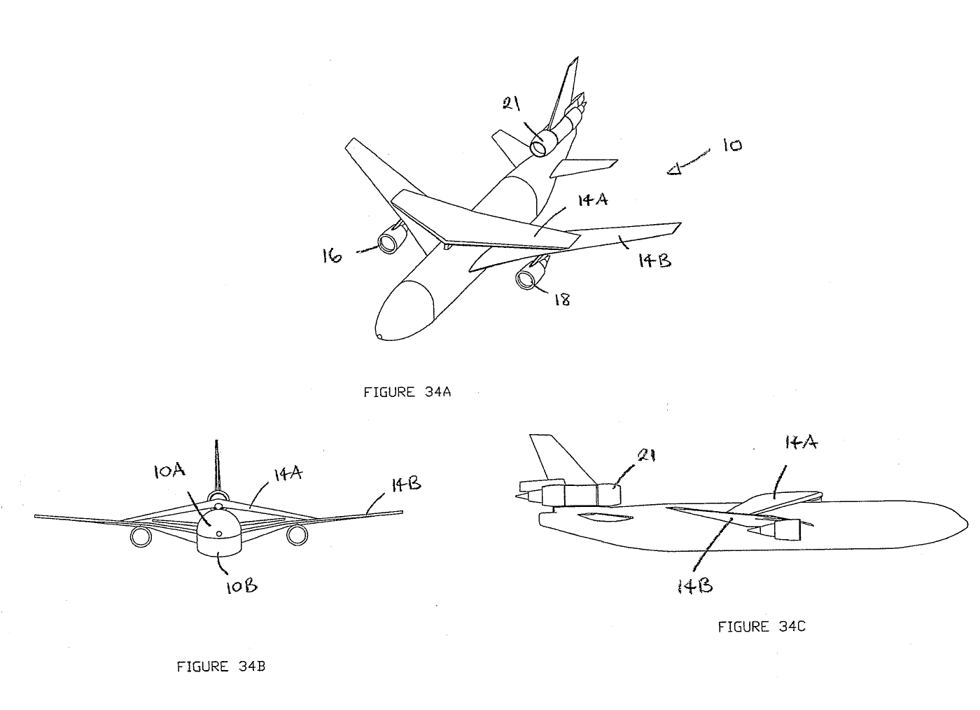

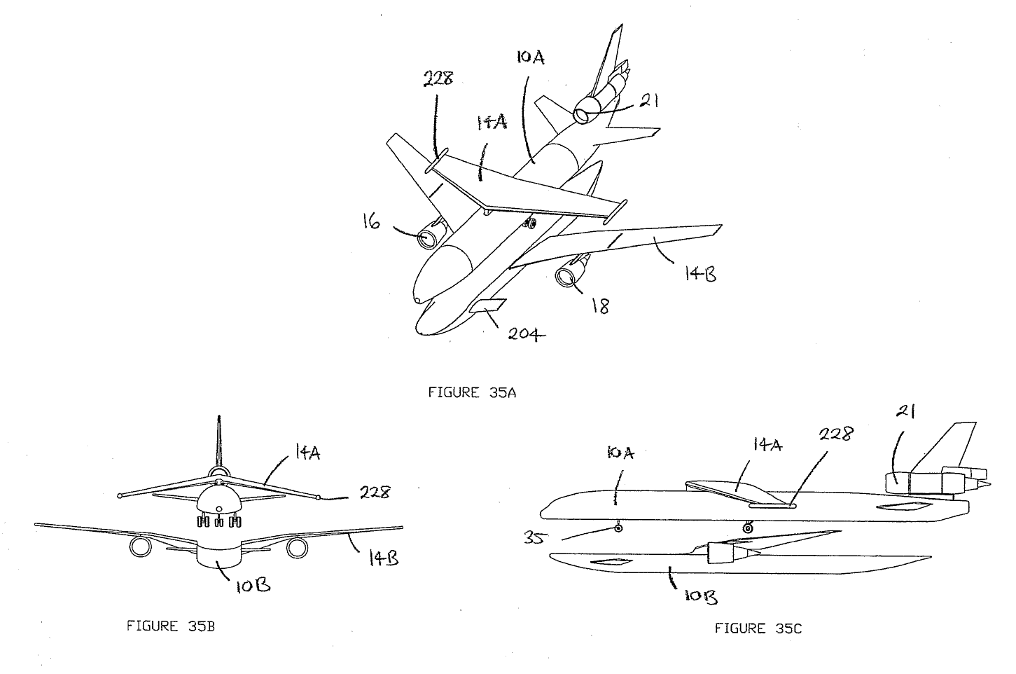

A crank-V aircraft 10 is shown in FIGS. 34A-34C and FIGS. 35A-35C as a further embodiment of the invention. The crank-V aircraft 10 includes upper pilotable portion 10A and lower jettisonable portion 10B. Upper pilotable portion 10A is provided with a pair of wings 14A attached midway along the wings 14B of the lower portion 10B. Wings 14A are detachably fastened to lower wings 14B with wing-locking mechanisms 228 as best seen in FIGS. 35A-35C. The wing locking mechanisms 228 are synchronised with the releasable engagement mechanisms 50 to maximise safety during the separation process. The crank-V wing configuration improves the aircraft's performance because all surfaces are being used for lift, and structural efficiency has been improved. The crank-V aircraft also incorporates two pressurised elliptical cylinders and vibration mitigation features as illustrated in FIG. 14D for high altitude operation.

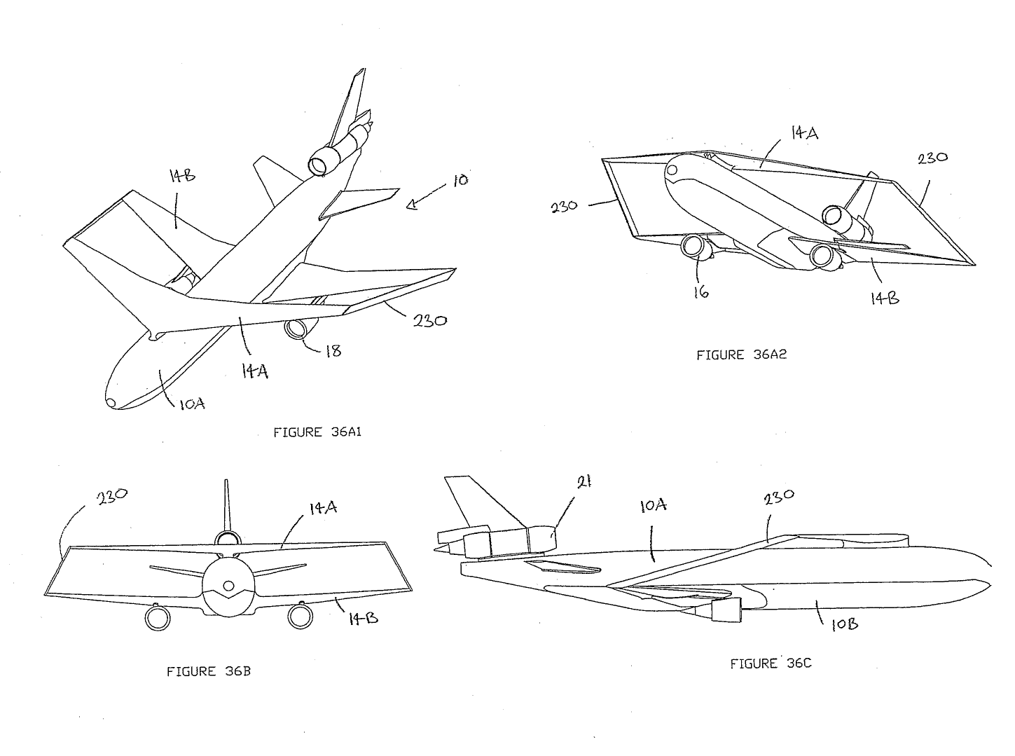

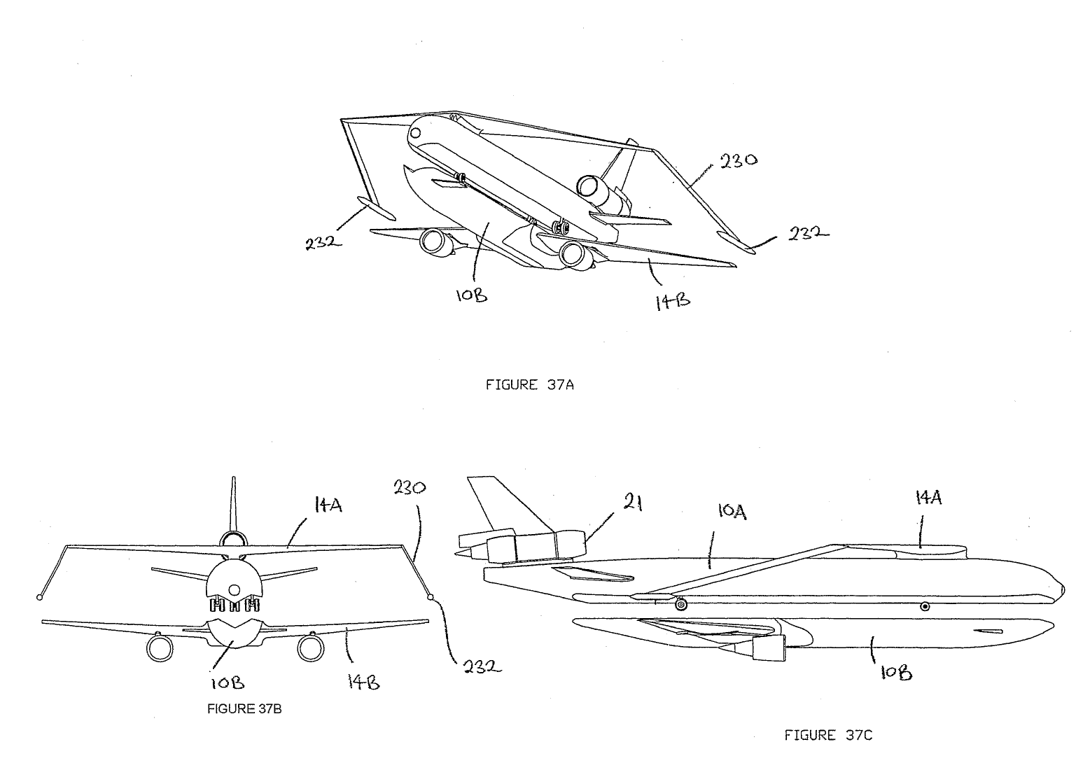

FIGS. 36A1-36C and FIGS. 37A-37C illustrate a further embodiment of the invention, namely a box-wing aircraft adapted for low altitude, non-pressurized separation. The box-wing aircraft is identical to the bi-plane of FIGS. 30A-30C and FIGS. 31A-31C with the addition of left and right struts 230 incorporated between the wings 14A of the upper pilotable portion 10A and the wings 14B of the jettisonable portion 14B. With this arrangement, the aircraft is structurally and aerodynamically improved. Loads and stiffness are transferred between the wings 14A, 14B by the struts 230, which also aerodynamically reduce the induced drag by minimising vortex effects at the wing tips.

This embodiment of the invention further includes water landing stabilisers 232 incorporated into the struts 230 of the aircraft. Water landing stabilisers 232 take the form of an inflatable bag mounted on each strut 230 which are inflated after the separation process and just prior to an emergency landing. The water landing stabilisers 232 together with the seaplane hull geometry of the upper pilotable portion 10A improve the performance of the upper portion 10A during an emergency water landing. The struts 230 may also incorporate a rudder (not shown) which can eliminate the need for vertical stabilisers and leading edge from the aft fuselage.

In the embodiments described above, engagement of the upper pilotable portion 10A and lower jettisonable portion 10B of the aircraft has been achieved via quick release engagement mechanisms 50 and, in the case of nested wing aircraft, an additional vacuum system applied to the wings 14A, 14B.

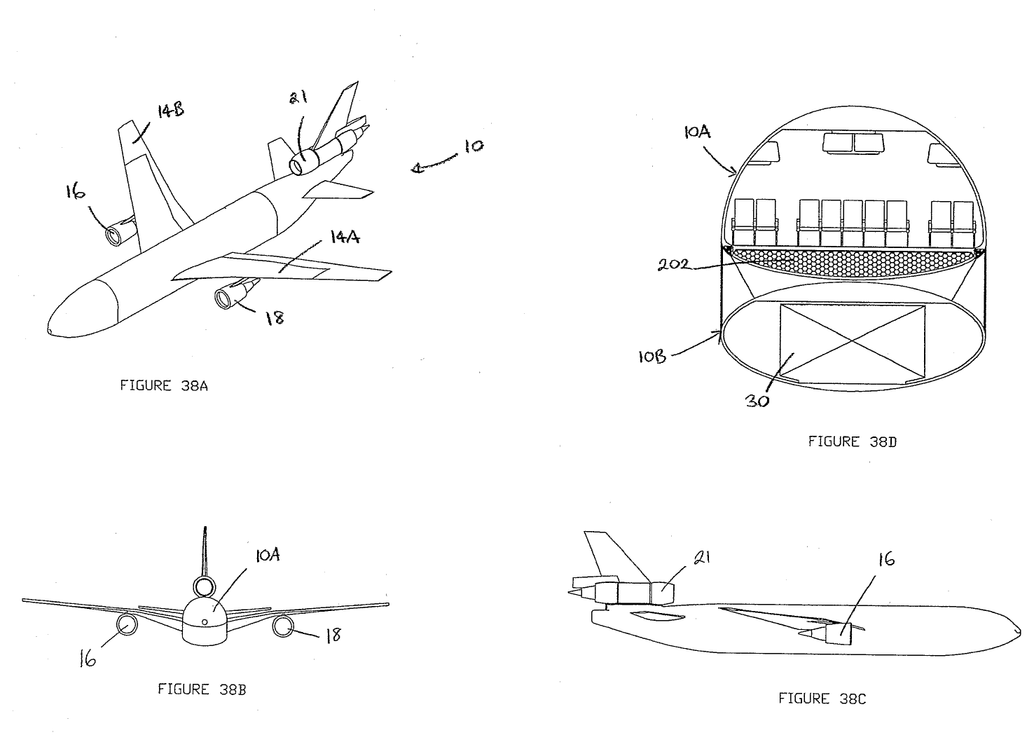

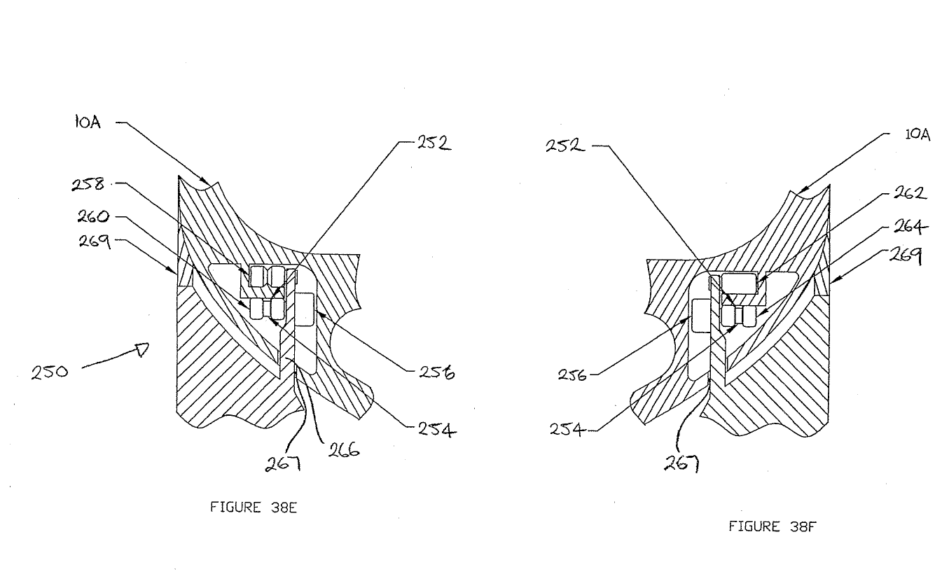

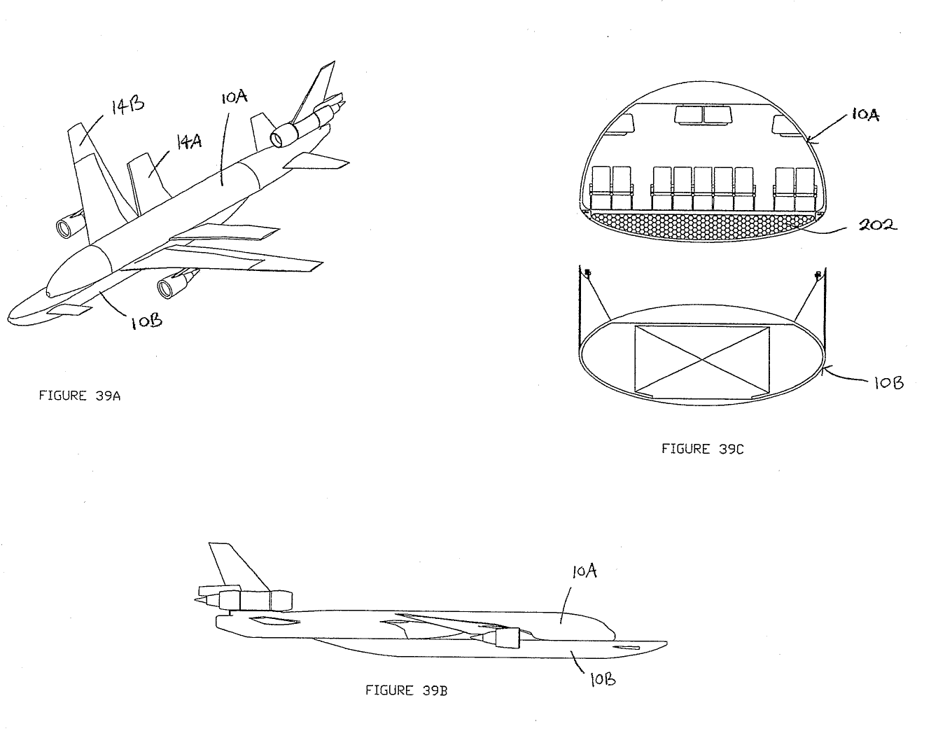

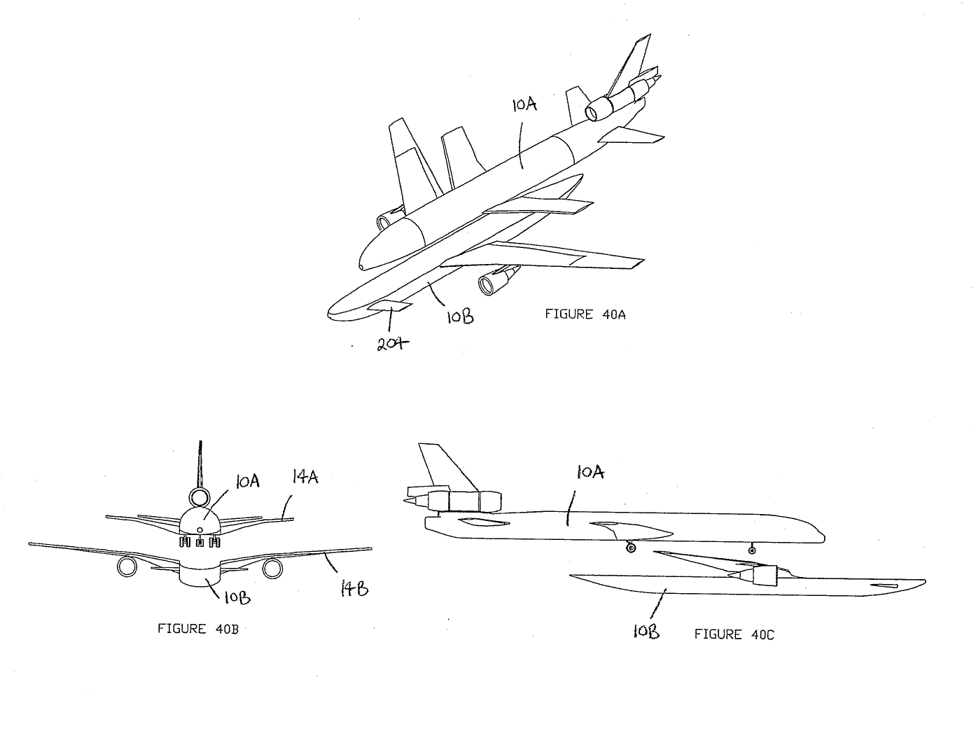

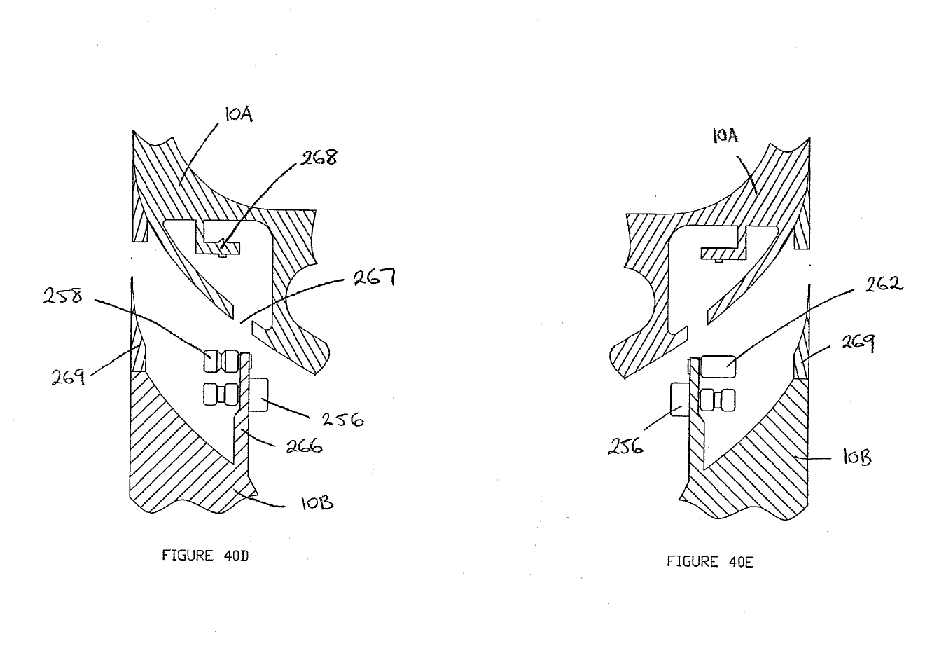

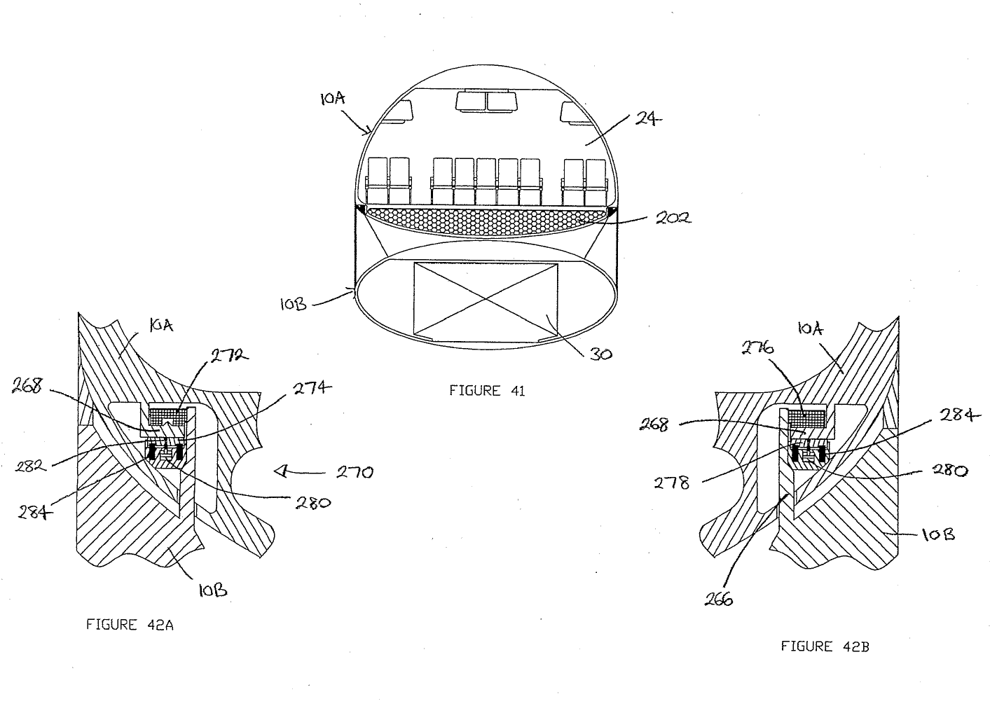

A further embodiment of the invention is illustrated in FIGS. 38A to 38F, FIGS. 39A to 39C, FIGS. 40A to 40E, FIG. 41, and FIGS. 42A to 42B. In this embodiment, the engagement mechanisms 50 are replaced by a sliding rail system 250 with associated brake mechanism 270.

The sliding rail system 250 consists of a rack 252 and gear 254 arrangement having an actuator 256, and a pair of rollers at one side of the aircraft comprising upper grooved roller 258, and lower roller 260, and on the opposite side of the aircraft upper roller 262 and lower roller 264. Rollers 258, 260, 262, 264, are provided on wall 266 of the lower jettisonable portion 10B of the aircraft, as best illustrated in FIGS. 38E and 38F. Wall 266 extends through aperture 267 provided in base of the upper pilotable portion 10A. Prior to separation of the upper pilotable portion 10A and the lower jettisonable portion 10B, the respective pairs of rollers 258, 260 and 262, 264 lie above and below and adjacent a lower horizontal wall 268 of the upper pilotable portion 10A. A seal 269 is provided between the upper pilotable portion 10A and lower jettisonable portion 10B.

The actuator 256 of the rack 252 and gear 254 is not required in all circumstances as the upper pilotable portion 10A and lower jettisonable portion 10B are generally able to slide freely once the braking mechanism 270 is deactivated as will be described below. In some circumstances, additional force is necessary to activate the separation process. The additional force can be provided by the actuator 256 and may include mechanical release devices and/or pneumatics. Separation may also be achieved by reversing a vacuum system into positive pressure.

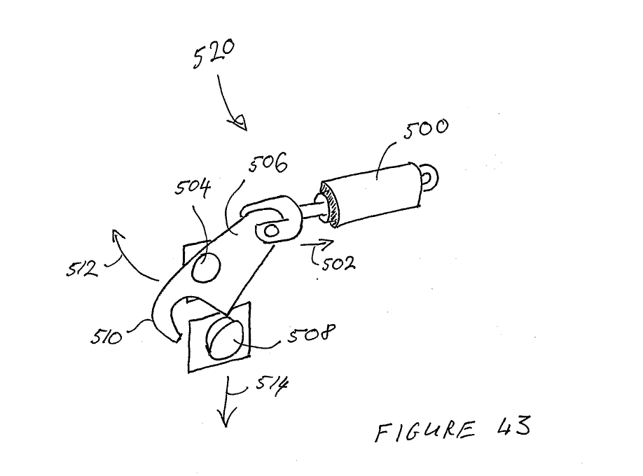

Referring now to the braking mechanism 270 as best illustrated in FIGS. 42A and 42B, the mechanism includes a pair of brake systems at each side of the aircraft, each brake system including a brake pad, shoe, and vibration mitigation material. Referring to the drawings there is illustrated upper grooved brake pad 272 and lower brake pad 274, and at the opposite side of the aircraft, upper brake pad 276 and lower brake pad 278.

The braking mechanism 270 further includes brake actuators 280, fasteners 282, and compression springs 284. When the brake mechanism 270 is activated, compression springs 284 serve to hold the fasteners 282 such that lower brake pads 274, 278 press against and engage wall 268 of the upper pilotable portion 10A. When the brakes are deactivated by actuators 280, springs 282 are released allowing the fasteners 282 and brake pads to be released.

During normal operation of the aircraft, the brake mechanism 270 is activated at all times in order to maintain a firm engagement between the upper pilotable portion 10A and lower jettisonable portion 10B. When needed, for example in an emergency condition, the brake mechanism is deactivated to allow the upper pilotable portion 10A and lower jettisonable portion 10B to slide with respect to one another and become separate. In aircraft with nested wings, the vacuum system applied to the wings 14A, 14B is simultaneously released with the braking system.

In the Figures, the lower jettisonable portion 10B is shown sliding forwardly of the upper pilotable portion 10A but it will be appreciated that the lower jettisonable portion could also slide rearwardly of the upper pilotable portion 10A.

FIG. 43 shows a hydraulic release mechanism 520 that may be used to force an initial separation between the upper fuselage portion and the lower fuselage portion. The hydraulic actuator 500 and pivoting arm 506 may be mounted on the upper fuselage portion 10A while the lug 508 is positioned on the lower fuselage portion 10B. While the two portions 10A, 10B are joined, a hook-shaped end 510 of the pivoting arm 506 retains the lug 508. When separation is initiated, the hydraulic actuator 500 pulls the pivoting arm 506 in direction 502. The arm 506 rotates about point 504 on the upper fuselage portion, moving in arcuate direction 512. The hook-shaped end 510 consequently releases the lug 508 and pushes the lug 514 in direction 514, thus pushing the upper and lower fuselage portions apart. Once air flows between the upper and lower portions, the two portions are forced further apart. An alternative method of separating the portion, is to reverse a vacuum pressure to produce a positive pressure.

It will be understood that the invention disclosed and defined in this specification extends to all alternative combinations of two or more of the individual features mentioned or evident from the text or drawings. All of these different combinations constitute various alternative aspects of the invention.

1. An aircraft comprising:
a fuselage having an upper pilotable fuselage portion and a lower jettisonable fuselage portion, the lower jettisonable fuselage portion being detachably engaged with the upper pilotable fuselage portion during normal flight;
an upper wing structure associated with the upper pilotable fuselage portion;
a lower wing structure associated with the lower jettisonable fuselage portion;
releasable engagement means for detachably engaging the lower jettisonable fuselage portion and the upper pilotable fuselage portion;
wherein the releasable engagement means is actuatable in flight to enable the upper pilotable fuselage portion and the lower jettisonable fuselage portion to be disengaged from one another; and
wherein the upper pilotable fuselage portion can be flown in the absence of the lower jettisonable fuselage portion.

2. An aircraft according to claim 1, wherein the aircraft is a fixed wing passenger aircraft.

3. An aircraft according to claim 1, wherein the upper pilotable fuselage portion includes a passenger compartment.

4. An aircraft according to claim 1, wherein the upper pilotable fuselage portion further includes a tail section and tail engine.

5. An aircraft according to claim 4, wherein the tail section is detachably engaged to the upper pilotable fuselage portion and is disengageable in an emergency condition.

6. An aircraft according to claim 1, wherein the lower jettisonable portion is able to fly independently after separation from the upper pilotable fuselage portion.

7. An aircraft according to claim 6, wherein the lower jettisonable portion further includes a global positioning system adapted to guide the lower jettisonable portion to predetermined safe landing locations.

8. An aircraft according to claim 1, wherein the upper wing structure includes fuel storage means for fuel used by the upper pilotable fuselage portion after separation from the lower jettisonable fuselage portion.

9. An aircraft according to claim 1, wherein the upper wing structure is nested in the lower wing structure during normal flight and acts as a single combined wing structure for the aircraft.

10. An aircraft according to claim 9, wherein the lower wing structure is releasably mounted to the upper wing structure by a releasable vacuum means.

11. An aircraft according to claim 10, wherein the releasable vacuum means is synchronised with the releasable engagement means to enable synchronised detachment of the upper and lower wing structures in an emergency condition.

12. An aircraft according to claim 1, wherein the upper wing structure and lower wing structure are separate from one another during normal flight.

13. An aircraft according to claim 1, wherein the lower jettisonable fuselage portion further includes primary landing gear, fuel tanks and cargo storage compartments.

14. An aircraft according to claim 1, wherein the upper pilotable fuselage portion has auxiliary controls and instrumentation, adapted to allow a person to pilot the pilotable portion after the lower jettisonable fuselage portion has separated from the upper pilotable fuselage portion.

15. An aircraft according to claim 14, wherein the auxiliary controls and instrumentation are separate and in addition to main controls and instrumentation used to pilot the aircraft prior to separation.

16. An aircraft according to claim 14, wherein the upper pilotable fuselage portion has an auxiliary piloting area, in which the auxiliary controls and instrumentation are located, which is separate and in addition to a main cockpit.

17. An aircraft according to claim 1, wherein the upper pilotable fuselage portion include auxiliary landing gear such that the upper pilotable fuselage portion can be landed once the lower jettisonable fuselage portion has been separated.

18. An aircraft according to claim 1, wherein the upper pilotable fuselage portion includes material to improve its buoyancy.

19. An aircraft according to claim 1, wherein the upper pilotable fuselage portion includes seaplane shaped hull geometry to assist in landing on water once the lower jettisonable fuselage portion has been separated.

20. An aircraft according to claim 1, wherein the releasable engagement means includes an array of releasable engagement mechanisms.

21. An aircraft according to claim 20, wherein each releasable engagement mechanism includes a detachably engageable jaw or clamping assembly.

22. An aircraft according to claim 20, wherein each releasable engagement mechanism comprises a release bolt having a head, and a clamping assembly.

23. An aircraft according to claim 22, wherein the clamping assembly comprises a pair of jaws which are movable between an engaged position in which the head of the release bolt is engaged and a release position in which the head of the release bolt is released.

24. An aircraft according to claim 1, wherein the releasable engagement means comprises a sliding rail arrangement to enable the upper pilotable fuselage portion and lower jettisonable fuselage portion to slide with respect to one another and become disengaged when the releasable engagement means is actuated.

25. An aircraft according to claim 24, wherein the sliding rail arrangement includes a rack and gear mechanism, and at least one complementary pair of rollers which enable sliding motion between the upper pilotable fuselage portion and lower jettisonable fuselage portion.

26. An aircraft according to claim 24, wherein the sliding rail arrangement further includes a braking mechanism which when activated prevents the upper pilotable fuselage portion and lower jettisonable fuselage portion from sliding with respect to one another, and when deactivated, enables the upper pilotable fuselage portion and lower jettisonable fuselage portion to separate.

27. An aircraft according to claim 1, wherein the aircraft is adapted for high altitude flight and separation.

28. An aircraft according to claim 27, wherein the upper pilotable fuselage portion and lower jettisonable fuselage portion are formed with elliptical cross sections designed to hold internal pressure before and after separation.

29. An aircraft according to claim 1, wherein the upper pilotable fuselage portion is adapted to fly as a glider after separation from the lower jettisonable fuselage portion.

30. An aircraft according to claim 4, wherein the aircraft includes a pair of tail engines.

31. An aircraft according to claim 4, wherein the tail engine is nested in the aft fuselage of the upper pilotable fuselage portion.

32. An aircraft according to claim 1, wherein the aircraft is a low earth orbit re-entry vehicle launcher.

33. An aircraft according to claim 1, wherein the aircraft is a supersonic delta aircraft.

34. An aircraft according to claim 1, wherein the aircraft is a transonic delta aircraft.

35. An aircraft according to claim 1, wherein the upper and lower wing structures are provided in a crank-V configuration,

36. An aircraft according to claim 1, wherein the aircraft is a box-wing aircraft.

37. An aircraft according to claim 36, wherein the upper pilotable fuselage portion further includes inflatable stabilisers for water landings.

38. An aircraft according to claim 1, wherein at least one of the upper and lower fuselage portions is fitted with deployable canards.

39. An aircraft according to claim 27, wherein the lower jettisonable portion is a reusable launcher.

40. (canceled)
